(19) United States
(12) Patent Application Publication
(10) Pub. No.: US 2023/0295357 A1
(43) Pub. Date: Sep. 21, 2023

(54) PHOTOPOLYMERIZABLE COMPOSITION, OPTICAL ELEMENT PREPARED THEREFROM, AND DISPLAY DEVICE

(71) Applicant: DONGJIN SEMICHEM CO., LTD., Incheon (KR)

(72) Inventors: Jonghyuk PARK, Hwaseong-si (KR); Hyoc-Min YOUN, Hwaseong-si (KR); Tai Hoon YEO, Hwaseong-si (KR); Sang-Hoon LEE, Hwaseong-si (KR); Wooram OH, Hwaseong-si (KR); Hyoseong AHN, Hwaseong-si (KR)

(21) Appl. No.: 18/324,765

(22) Filed: May 26, 2023

Related U.S. Application Data
(63) Continuation of application No. PCT/KR2021/017596, filed on Nov. 26, 2021.

(30) Foreign Application Priority Data
Nov. 27, 2020 (KR) 10-2020-0162700
Nov. 25, 2021 (KR) 10-2021-0164737

(51) Int. Cl. C08F 220/12; C09D 133/08

(52) U.S. Cl. CPC C08F 220/12; C09D 133/08

(57) ABSTRACT

A photopolymerizable composition is provided, which enables formation of an optical member exhibiting improved optical properties including excellent high flexibility, high refractive index, light transmittance, and low haze, and includes viscosity properties suitable for inkjet processes; an optical element prepared therefrom; and a display device. The photopolymerizable composition includes at least one high refractive index monomer having a liquid refractive index of 1.51 or more before curing, at least one flexible monomer, and a photopolymerization initiator.

### CROSS-REFERENCE TO RELATED APPLICATIONS

This application is a Continuation of International Application No. PCT/KR2021/017596 filed on Nov. 26, 2021, which claims priority from Korean Application No. KR 10-2020-0162700 filed on Nov. 27, 2020 and Korean Application No. KR 10-2021-0164737 filed on Nov. 25, 2021. The aforementioned applications are incorporated herein by reference in their entireties.

### TECHNICAL FIELD

The present disclosure relates to a photopolymerizable composition which simultaneously improves not only optical properties including excellent light transmittance, low haze and high refractive index, but also mechanical properties including high flexibility and excellent bending reliability; an optical element prepared therefrom; and a display device including the same.

### BACKGROUND ART

In the case of a light transmissive optical film having a structured prism, the luminance increase rate changes depending on the refractive index of the resin constituting a prism structure. Generally, as the refractive index of the resin constituting the prism increases, the luminance increase rate increases. Therefore, with regard to the light transmissive optical film, research and development have been advanced in the direction of increasing the refractive index of the resin constituting the prism structure.

The high refractive index resin constituting the prism is generally formed by dispersing a metal oxide in an organic compound in order to secure a high refractive index. Although it has a high refractive index due to the use of metal oxides, there is a problem that haze and reflectance are also increased. High reflectance leads to deterioration of outdoor visibility of the display.

The product shelf life of the resin formed in the form of the metal oxide dispersion is determined by dispersion stability, which makes mass production difficult and causes an increase in unit price. In addition, in the case of the composition containing the metal oxide, it shows problems such as an increase in the viscosity, or a decrease in the inkjet processability, and thus is subject to many technical restrictions.

Moreover, when the resin and the optical film are formed by using an existing general photopolymerizable composition as a monomer composition, in many cases, surface curing would not occur sufficiently due to the influence of oxygen in the air in the process of photocuring the monomer composition. As a result, the resin and the optical film have a problem that haze increases, and light transmittance such as ultraviolet transmittance and visibility are lowered. Further, insufficient surface curing degrades the mechanical properties of the film, which leads to the drastic deterioration of the high flexibility and bending reliability required for foldable devices. Therefore, in consideration of the above problems, a method of performing the curing process in an inert gas atmosphere such as nitrogen has been considered, but this may lead to a significant increase in the production cost.

With the recent development of display-related techniques, deformable display devices such as folding, rolling in a roll shape, or stretching like a rubber band have been developed and mass-produced. Since these displays can be deformed into various shapes, the materials used are also required to have deformable mechanical properties.

However, due to the above-mentioned problems, it has not been developed to a satisfactory level in terms of excellent optical properties, high flexibility and the like, while exhibiting viscosity properties suitable for the inkjet process. Therefore, there is a continued need to develop techniques which enable the formation of optical films and the like exhibiting excellent optical and mechanical properties.

### SUMMARY

It is an object of the present disclosure to provide a photopolymerizable composition which enables formation of an optical member suppressing the increase in haze during the curing process, while exhibiting viscosity properties suitable for inkjet processes, thereby exhibiting not only improved optical properties, including excellent light transmittance, low haze and high refractive index, but also improved mechanical properties, including high flexibility (elongation) and excellent bending reliability.

It is another object of the present disclosure to provide an optical member which is prepared from the photopolymerizable composition, and has improved optical properties including excellent light transmission, low haze and high refractive index, and mechanical properties such as high flexibility and excellent bending reliability.

It is yet another object of the present disclosure to provide a display device comprising the optical member.

According to an aspect of the present disclosure, a photopolymerizable composition may include:

a) at least one high refractive index monomer having a liquid refractive index of 1.51 or more before curing;

b) at least one highly flexible monomer; and

c) a photopolymerization initiator.

Also provided herein is an optical member comprising: a substrate; and a cured film including a cured product of the photopolymerizable composition.

Further provided herein is a display device comprising the optical member.

The photopolymerizable composition according to the present disclosure enables the formation of a cured film satisfying a high refractive index while exhibiting viscosity properties suitable for an inkjet process and an optical member including the film. Further, due to the specific highly flexible monomer contained in the photopolymerizable composition, mechanical properties such as flexibility and bending reliability of the cured product can be improved. By the action of the amine synergist contained in the photopolymerizable composition, the problem of reduced surface curability due to the influence of oxygen can be greatly reduced, and as a result, it becomes possible to form an optical member exhibiting low haze, excellent light transmittance such as ultraviolet transmittance, and high visibility.

In addition, in the curing process of the photopolymerizable composition, the application of a nitrogen atmosphere or the like is not necessary, so that the economic efficiency of the overall process can also be greatly improved.

Therefore, the optical member prepared from the photopolymerizable composition exhibits low haze, high refractive index, excellent light transmittance, visibility, and the like while having a low production cost, and thus can greatly contribute to the improvement of the characteristics of a foldable or flexible display device.

### DETAILED DESCRIPTION

Hereinafter, embodiments of the present disclosure will be described in more detail. It will be understood that words or terms used in the specification and the appended claims shall not be interpreted as being limited to the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

The term “including” or “comprising” as used herein specifies a specific feature, region, integer, step, action, element and/or component, but does not exclude the presence or addition of a different specific feature, region, integer, step, action, element, and/or component.

The (meth)acrylate as used herein includes both acrylate and methacrylate.

Hereinbelow, various embodiments of the present disclosure will be described in detail so that those skilled in the art can easily implement them. The embodiments can be modified in various different ways, and the present disclosure is not limited to the specific embodiments set forth herein.

According to an embodiment of the disclosure, there is provided a photopolymerizable composition comprising: a) at least one high refractive index monomer having a liquid refractive index of 1.51 or more before curing; b) at least one highly flexible monomer; and c) a photopolymerization initiator.

The photopolymerizable composition of one embodiment can realize high refractive index properties by the use of only high refractive index monomer, even without including a metal oxide, and can prevent cracks of the cured film by including a highly flexible monomer having excellent flexibility (elongation). Therefore, the optical member including the cured film formed from the photopolymerizable composition can be applied to a foldable or flexible display device to improve the performance of the display device. In addition, the photopolymerizable composition satisfies a viscosity range suitable for use in inkjet applications even if it contains only a high refractive index monomer and a highly flexible monomer, and can realize excellent optical properties and mechanical properties for a cured product.

The photopolymerizable composition does not use a metal oxide, and thus has excellent surface curability during photocuring process, so that haze properties, light transmittance, and visibility of the optical film can be improved, and factors that increase the production cost can be prevented. In particular, due to the use of the highly flexible monomer, cracks can be prevented as described above, so that excellent high flexibility and bending reliability required for a foldable or flexible device can be secured. In addition, in the curing process of the photopolymerizable composition, it is not necessary to apply a nitrogen atmosphere or the like, so that the economic efficiency of the overall process can also be greatly improved.

Moreover, the photopolymerizable composition further includes at least one component such as an amine synergist, a photosensitizer, and a surfactant, thereby being able to improve surface curability for providing a cured film. For example, it was confirmed that the problem of deterioration of the surface curability due to the influence of oxygen can be greatly reduced by the action of the amine synergist contained in the photopolymerizable composition. This seems to be because during the curing process, as the amine group contained in the amine synergist captures oxygen radicals in the air, the reactivity of the polymerization initiator can be further increased. Moreover, the use of the photosensitizer can promote the polymerization reaction during photopolymerization. Further, the use of the surfactant can impart effects such as improving uniformity of the film thickness and surface smoothness.

Therefore, when the photopolymerizable composition of one embodiment, which may include not only the composition of the high refractive index monomer, highly flexible monomer, and photopolymerization initiator, but also additional components, is photocured to form a cured film and an optical member, a high surface curability can be achieved even in an air atmosphere, so that the cured film or the like can exhibit low haze, excellent light transmittance such as UV transmittance, and high visibility. In particular, the photopolymerizable composition has significantly improved high flexibility and bending properties, and exhibits a viscosity suitable for inkjet printing, thereby improving processability such as application and film formation. In addition, in the curing process of the photopolymerizable composition, it is not necessary to apply a nitrogen atmosphere or the like, so that the economic efficiency of the overall process can also be greatly improved.

Therefore, when the photopolymerizable composition is used, the formation of the optical member showing low haze, high refractive index, high flexibility, excellent light transmission and visibility, etc. while having a low production unit cost, becomes possible, which can greatly contribute to the improvement of the characteristics of various types of display devices.

Specifically, each component used in the photopolymerizable composition will be described below.

The photopolymerizable composition of one embodiment is a basic monomer for forming a cured film matrix, and includes at least one high refractive index monomer having a liquid refractive index of 1.51 or more before curing.

In the high refractive index monomer, the photocurable functional group is crosslinked and polymerized via a photopolymerization initiator by the photocuring process described later to form a basic resin constituting a cured film. In particular, the high refractive index monomer can improve the refractive index of a cured film by UV irradiation or the like as it satisfies a specific liquid crystal refractive index range. More specifically, the liquid phase refractive index of the high refractive index monomer before curing may be 1.51 to 1.60. If the liquid phase refractive index of the high refractive index monomer is 1.51 or less, there is a problem that the refractive index of the cured film is lowered to 1.58 or less.

The high refractive index monomer may be an aromatic or alicyclic photocurable compound containing one or more aromatic rings or one or more heteroatoms.

Specifically, the high refractive index monomer may be an aromatic or alicyclic photocurable compound having a photocurable functional group having 10 to 40 carbon atoms containing one or more aromatic rings or containing one or more heteroatoms.

More specifically, the high refractive index monomer may be an aromatic photocurable compound including a structure of the following Chemical Formula 1:

B—Z1—Z2—R [Chemical Formula 1]

wherein, in Chemical Formula 1, B includes an aryl group having 6 to 30 carbon atoms, at least one structure of a 5-7 membered aliphatic heterocyclic structure substituted with one or more sulfur (S) or a 5-7 membered aromatic heterocyclic structure substituted with one or more sulfur (S),

Z1 is a direct bond or an alkyl group having 1 to 10 carbon atoms,

Z2 is a direct bond or an alkyl group having 1 to 10 carbon atoms containing at least one oxygen (O) or sulfur (S), and

R is a photocurable functional group.

The high refractive index monomer may include a structure of Chemical Formula 1 where B is an aryl group having 6 to 30 carbon atoms, Z1 is a direct bond, and Z2 is an alkyl group of 1 to 10 carbon atoms containing at least one oxygen (O).

The high refractive index monomer includes a structure of Chemical Formula 1 where B is an aryl group having 6 to 30 carbon atoms, Z1 is a direct bond, and Z2 includes at least one oxygen (O) and an aromatic ring structure together.

The high refractive index monomer may include a structure of Chemical Formula 1 where B includes a 5-7 membered aromatic heterocyclic structure substituted with at least one sulfur (S). Z1 is a direct bond, and Z2 is an alkyl group of 1 to 10 carbon atoms containing at least one sulfur (S).

The high refractive index monomer may be in a liquid state, but in the case of a structure containing anthracene or sulfur represented by Chemical Formula 1, it may exist in a powder form rather than a liquid state.

More specifically, the above-mentioned high refractive index monomer may include at least one selected from the group consisting of benzyl (meth)acrylate, phenoxyethyl (meth)acrylate, phenoxybenzyl (meth)acrylate, O-phenylphenoxyethyl (meth)acrylate, biphenyl ethyl (meth)acrylate, and the following Chemical Formulas 2 to 8.

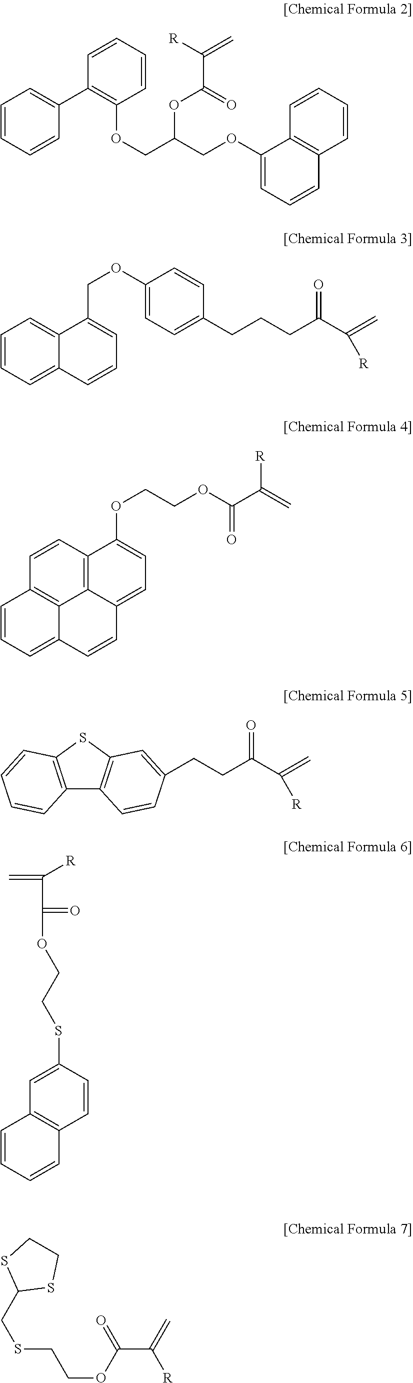

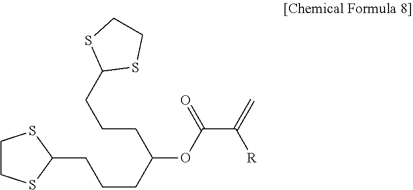

(wherein, in Chemical Formulas 2 to 8, each R is independently H or CH₃)

In particular, the high refractive index monomer may secure a refractive index of 1.61 or more in the case of an anthracene or sulfur-containing structure.

Meanwhile, the highly flexible monomer according to the present disclosure is cured together with the high refractive index monomer, thereby greatly improving the flexibility and bending properties of the cured film and preventing cracks.

Specifically, the highly flexible monomer may include a compound having at least one photocurable functional group capable of improving the elongation of a final cured film by at least 5% or more.

After a 20 μm thick film is removed from a bare glass to prepare a dog bone specimen (size: 28 mm×4 mm), the elongation is determined according to a tensile stress strain curve measured using Instron's UTM.

The highly flexible ionomer may include a structure of the following Chemical Formula 9.

(A)m-B(A′)n [Chemical Formula 9]

wherein, in Chemical Formula 9,

A and A′ are photocurable functional groups, which may be identical or different,

B is an aliphatic structure having 6 to 50 carbon atoms containing or not containing one or more oxygen atoms, and includes a liner alkyl structure having at least 6 or more carbon atoms, and

m and n are integers of 0 or 1.

The highly flexible monomer may have a structure of Chemical Formula 9 where B contains 4 to 20 oxygen atoms.

More specifically, the highly flexible monomer may be at least one selected from the group consisting of an aliphatic mono(meth)acrylates containing 6 to 30 carbon atoms and an aliphatic di(meth)acrylate containing 6 to 30 carbon atoms. The viscosity of the highly flexible monomer may be 1 to 30 cP.

Still more specifically, the highly flexible monomer may include at least one selected from the group consisting of isodecyl (meth)acrylate, lauryl (meth)acrylate, stearyl (meth)acrylate, ethoxy ethyl (meth)acrylate, ethoxy ethoxy ethyl (meth)acrylate, triethylene glycol di(meth)acrylate, tetraethylene glycol di(meth)acrylate, dipropylene glycol di(meth)acrylate, tripropylene glycol di(meth)acrylate and the following Chemical Formula 10.

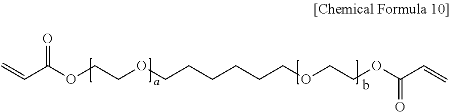

(wherein, in Chemical Formula 10, 0≤a+b≤10, and a and b are integers)

In Chemical Formula 10, a and b may be integers of 1 to 5, respectively.

Such a highly flexible monomer may include at least 10 parts by weight or more based on total 100 parts by weight of the high refractive index monomer and the highly flexible monomer. Specifically, the highly flexible monomer must be contained in an amount of 10 parts by weight or more in the photopolymerizable composition to improve the flexibility of the cured film.

More specifically, the high flexibility monomer may be contained in an amount of 10 to 90 parts by weight based on total 100 parts by weight of the high refractive index monomer and the high flexibility monomer. In addition, the high flexibility monomer may be contained 10 to 40 parts by weight based on total 100 parts by weight of the high refractive index monomer and the high flexibility monomer.

When the content of the highly flexible monomer is as low as less than 10 parts by weight, the elongation after the formation of the coating film is less than 5%, so the flexibility cannot be improved. Further, if the content of the highly flexible monomer is excessively high at 90 parts by weight or more, there is a problem that the refractive index becomes low and a high refractive index of 1.58 or more cannot be achieved.

The photopolymerizable composition of one embodiment described above includes a photopolymerization initiator. Such a photopolymerization initiator can initiate and accelerate the photocuring reaction of the two types of specific monomers described above.

As such a photopolymerization initiator, any initiator known to be capable of initiating and accelerating a photocuring reaction of a photocurable functional group such as a (meth)acrylate group can be used.

Examples of the photopolymerization initiator include at least one selected from the group consisting of triazine-based, benzoin-based, benzophenone-based, imidazole-based, xanthone-based, oxime ester-based, and acetophenone-based compounds. More specific examples of the photopolymerization initiator may include at least one selected from the group consisting of 2,4-bistrichloromethyl-6-p-methoxystyryl-s-triazine, 2-p-methoxystyryl-4,6-bistrichloromethyl-s-triazine, 2,4-trichloromethyl-6-triazine, 2,4-trichloromethyl-4-methylnaphthyl-6-triazine, 2-(0-chlorophenyl)-4,5-diphenyl imidazole dimer, 2-(o-chlorophenyl)-4,5-di(m-methoxyphenyl)imidazole dimer, 2-(o-fluorophenyl)-4,5-diphenyl imidazole dimer, 2-(o-methoxyphenyl)-4,5-diphenyl imidazole dimer, 2-(o-methoxyphenyl)-4,5-diphenyl imidazole dimer, 2,4-di(p-methoxy phenyl)-5-phenyl imidazole dimer, 2-(2,4-dimethoxyphenyl)-4,5-diphenyl imidazole dimer, 2-(p-methylmercaptophenyl)-4,5-diphenyl imidazole dimer, [1-[9-ethyl-6-(2-methylbenzoyl)-9H-carbazolyl-3-yl]-1-(O-acetyloxime), benzophenone, p-(diethyl amino)benzophenone, 2,2-dichloro-4-phenoxyacetophenone, 22-diethoxyacetophenone, 2-dodecylthioxanthone, 2,4-dimethylthioxanthone, 2,4-diethylthioxanthone, 2,2-bis-2-chlorophenyl-4,5,4,5-tetraphenyl-2-1,2-biimidazole, (E)-2-(acetoxyimino)-1-(9,9-diethyl-9H-fluorene-2-yl)butanone, (E)-1-(9,9-dibutyl-7-nitro-91-fluorene-2-yl)ethanone 0-acetyloxime, (Z)-2-(acetoxyimino)-1-(9,9-diethyl-9H-fluorene-2-yl)propanone, Irgacure 369, Irgacure 651, Irgacure 907, Darocur TPO, Irgacure 819, OXE-01, OXE-02, OXE-03, OXE-04, N-1919, NCI-831 and NCI-930 (available from ADEKA). In addition, a photopolymerization initiator known in the art can be widely used without particular limitation.

The photopolymerization initiator can be contained in an amount of 0.5 to 30 parts by weight based on total 100 parts by weight of the high refractive index monomer and the highly flexible monomer. In another example, the photopolymerization initiator can be contained in an amount of 0.6 to 28% by weight, or 1 to 25% by weight based on total 100 parts by weight of the high refractive index monomer and the highly flexible monomer. If the content of the photopolymerization initiator is too low, photocuring may not occur properly. On the contrary, if the content is too high, the integrated transmittance of the cured film or the like may be decreased to, for example, 90% or less.

Meanwhile, the composition of one embodiment may have an absolute viscosity suitable for an inkjet process by using the above-mentioned high refractive index monomer and highly flexible monomer without including a metal oxide. Specifically, the photopolymerizable composition may have an absolute viscosity (measured at 25° C.) of 5 cP to 40 cP. Therefore, the composition of the embodiment including the same enables the formation of a cured film which is excellent in the processability by an inkjet process, and excellent in heat resistance and mechanical properties and has good coating film properties. Further, the cured film and the optical member formed from the composition according to one embodiment may have a high refractive index of 1.58 or more due to the interaction between the olefinic monomer and the metal oxide particles described later.

For reference, the absolute viscosity described herein means an absolute viscosity value measured at 25° C., and such absolute viscosity can be measured using a viscometer well known in the art, for example, a Brookfield viscometer.

Meanwhile, the photopolymerizable composition of one embodiment may further include at least one selected from the group consisting of d) an amine synergist having an amine group and a photocurable functional group, e) a photo sensitizer, and f) a surfactant. By further including any one or more additives among the above components d) to f), the photopolymerizable composition can contribute to more effectively realizing physical properties.

First, the photopolymerizable composition of one embodiment includes an amine synergist having an amine group and a photocurable functional group. In regard to the amine synergist, in the process of photocuring the composition of one embodiment to form a cured film and an optical member, the amine group contained therein can capture oxygen radicals and the like in the air to accelerate the reaction of the initiator. Furthermore, the photocurable functional group in the amine synergist may participate in a curing reaction together with the monomer to form a cross-linkage. Due to the action of such an amine synergist, the cured film and the optical member formed from the composition of one embodiment can exhibit a high surface curability, whereby excellent optical properties such as low haze and improved light transmittance can be exhibited.

The amine synergist may include one selected from the group consisting of a compound having a tertiary or higher amine group and a photopolymerizable acrylate group in the molecule.

Specifically, as the amine synergist, a functional group capable of forming a cross-linkage between an amine group in the molecule and a photocurable functional group, for example, a photocurable functional group of the above-mentioned monomer can be used. In a more specific embodiment, any compound having a (meth)acrylate group which is the same type of photocurable functional group as the monomer can be used. Further, in order to more effectively capture the oxygen radicals and the like to further increase the surface curability of the cured film, and the like, it is more preferable that the amine synergist includes a tertiary or higher amine structure in the molecule.

Specific examples of such amine synergists may include at least one selected from the group consisting of a compound of the following Chemical Formula 11, ethyl dimethylamino benzoate, butoxyethyl dimethylamino benzoate, bis(diethylamino)benzophenone, bis(2-hydroxyethyl)-toluidine, ethylhexyl-(diethylamino)benzoate, 2-(dimethylamino)ethyl (meth)acrylate, diethylaminoethyl(meth)acrylate, 2-(diisopropylamino)ethyl (meth)acrylate, 2-(acryloyloxy)ethyl 4-(dimethylamino)benzoate, 2-ethylhexyl 4-(dimethylamino)benzoate, ethyl 2-(dibutylamino)methyl acrylate and 4,4-(oxybis(ethane-2,1-diyl))bis(oxy)bis(dimethylaniline). In addition, various other compounds having amine groups and photocurable functional groups can also be used.

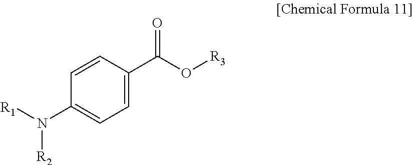

wherein, in Chemical Formula 11, R₁ and R₂ each independently represent an alkyl group having 1 to 5 carbon atoms, and R₃ represents an alkyl group having 1 to 20 carbon atoms, an ether group having 1 to 20 carbon atoms, an aryl group, an amine group or a (meth)acrylate group having 6 to 30 carbon atoms.

Further, a commercially available amine-based photocurable compound can also be used as the amine synergist, and examples of such a commercialized compound include P115 (manufactured by SK Cytec), MIRAMER AS2010 (manufactured by Miwon Specialty Chemical Co., Ltd.), or MIRAMER AS5142 (manufactured by Miwon Specialty Chemical Co., Ltd.), and the like.

Further, the photopolymerizable composition may further include 0.1 to 10 parts by weight of an amine synergist based on total 100 parts by weight of the high refractive index monomer and the highly flexible monomer. In another example, the d) amine synergist can be included in an amount of 0.5 to 9 parts by weight based on total 100 parts by weight of the high refractive index monomer and the highly flexible monomer. If the content of the amine synergist is too low, the surface curability may be deteriorated, and the haze of the cured film and the optical member may be increased. On the contrary, if the content thereof is too high, the viscosity of the photopolymerizable composition may be excessively high, so that the processability may be deteriorated, or the refractive index of the cured film or the like may be decreased.

The e) photosensitizer is contained in the photopolymerizable composition to further increase the curability of the high refractive index monomer and the highly flexible monomer, thereby imparting the effects of improving haze properties and increasing sensitivity.

The photosensitizer may be at least one selected from the group consisting of isopropyl thioxanthone, pyrene, perylene, triphenylene, anthracene, 9,10-dibutoxyanthracene, 9,10-diethoxyanthracene, 3,7-dimethoxyanthracene, and 9,10-dipropyloxyanthracene.

The photopolymerizable composition may include 0.1 to 10 parts by weight of a photosensitizer based on total 100 parts by weight of the high refractive index monomer and the highly flexible monomer. In another example, the photopolymerizable composition may comprise 0.5 to 9 parts by weight of a photosensitizer based on total 100 parts by weight of the high refractive index monomer and the highly flexible monomer. If the content of the photosensitizer is too low, it cannot contribute to the improvement of the surface curability. On the contrary, if the content thereof is too high, the viscosity of the photopolymerizable composition becomes excessively high and the processability is lowered or the transmittance of the cured film and the like is lowered.

The f) surfactant can impart effects such as improving uniformity or surface smoothness of the film thickness.

The surfactant may include at least one selected from the group consisting of silicon-based and fluorine-based surfactants.

The f) surfactant may be contained in an amount of 0.1 to 5 parts by weight based on total 100 parts by weight of the high refractive index monomer and the highly flexible monomer. If the content of the surfactant is too low, there is a problem that the uniformity and surface smoothness of the film thickness are deteriorated. On the contrary, if the content thereof is too high, there are problems that air bubbles are generated inside the film or inkjet ejection properties are deteriorated.

Meanwhile, the photopolymerizable composition of one embodiment may further include a dispersant in addition to each component described above, if necessary. Such a dispersant can be included in the above-mentioned photopolymerizable composition to improve the dispersion stability of other components.

The type of such a dispersant is not particularly limited, and any dispersant known to be usable for improving dispersibility can be used. Examples of such a dispersant include at least one selected from the group consisting of an acryl-based dispersant, an epoxy-based dispersant, and a silicone-based dispersant.

The dispersant may be contained in an amount of 0.1 to 30 parts by weight, or 0.5 to 20 parts by weight, based on total 100 parts by weight of the high refractive index monomer and the highly flexible monomer. Depending on the content of the dispersant, each component can be uniformly dispersed, so that a desired refractive index range of the cured film can be more effectively achieved. However, if the content of the dispersant is excessively high, the viscosity of the photopolymerizable composition may increase and the inkjet processability may decrease.

Further, the composition of the one embodiment described above may be prepared in a solvent-free type that does not include a separate solvent or liquid medium. Thereby, the processability using the composition of the embodiment can be further improved.

The photopolymerizable composition of an embodiment including each of the above-mentioned components may have an absolute viscosity (measured at 25° C.) of 5 to 40 cP or 5 cP to 30 cP. The absolute viscosity can be measured using a well-known viscosity measuring instrument, for example, a Brookfield viscosity measuring instrument. As the photopolymerizable composition of one embodiment satisfies this viscosity range, not only it is excellent in processability by the inkjet application process or the like while enabling the formation of a cured film having excellent heat resistance and mechanical properties, but also it is possible to form a good coating film by the inkjet application process.

If the viscosity of the final composition is too low, nozzle drying and clogging may cause deterioration of discharge characteristics. Moreover, when the viscosity of a composition is too high, discharge amount decreases and a pattern and surface formation do not occur.

Meanwhile, according to another embodiment of the invention, a cured film including a cured product of the above-mentioned photopolymerizable composition and an optical member including the same are provided. Such an optical member may include a substrate; and the cured film formed on the substrate. Further, as the cured film is formed by photocuring after the photopolymerizable composition of an embodiment is applied on a substrate using an inkjet application process, it can mainly include a polymer containing a unit in which the photocurable functional groups of the olefinic monomer and the amine synergist are crosslinked, and a cured product comprising a dispersant and a metal oxide dispersed on the polymer.

More specifically, the cured product includes an olefin resin crosslinked by curing a high refractive index monomer and a high flexible monomer, and the olefin resin may optionally be further crosslinked with the photocurable functional group of the amine synergist. Further, the olefin resin can be combined with at least one selected from the group consisting of the above-described photosensitizer and surfactant to improve photopolymerization and film properties. At this time, the olefin resin is a polymer crosslinked from a high refractive index monomer having at least one photocurable functional group and at least one highly flexible monomer, and the form thereof is not particularly limited, and can have various forms such as a homo copolymer, a block copolymer, a random copolymer, or a graft copolymer, depending on the type of the monomer and the mechanism of the polymerization reaction.

Meanwhile, according to another embodiment of the disclosure, there can be provided an optical member comprising: a substrate; and a cured product of the photopolymerizable composition for highly flexible inkjet.

As the cured film including the cured product is formed of the photopolymerizable composition of one embodiment having a viscosity suitable for an inkjet application process, it can exhibit excellent heat resistance and mechanical properties, and good coating film properties. Further, the cured film may have a haze of 3% or less, a refractive index of 1.58 or more, and an elongation of 5% or more.

Specifically, the cured film may have a refractive index of 1.58 or more after photopolymerization based on a wavelength of 565 nm. More specifically, the cured film may have a high refractive index of 1.6 or more, or 1.6 to 2.0, or 1.6 to 1.65. At this time, the refractive index may mean a value measured with respect to a wavelength of 555 to 575 nm (average) using an ellipsometer.

In addition, due to the action of the amine synergist, the cured film exhibits a high surface curability, for example, a low haze of 3% or less, or 1% or less, or 0 to 1%, or 0.01 to 0.8%, or 0.1 to 0.3%, and excellent light transmittance such as UV transmittance and visibility.

In addition, the cured film may have an elongation of 5% or more, 5 to 10%, or 10% or more, which is determined according to a tensile stress strain curve measured using Instron's UTM after removing a 20 μm thick film from the bare glass to prepare a dog bone specimen (size: 28 min×4 mm).

In the above-mentioned optical member, a well-known substrate such as bare glass can be used as the substrate.

Further, the optical member can be produced by applying the photopolymerizable composition of the one embodiment described above onto the substrate using a Mayer bar, a coating applicator, inkjet equipment, or like, for example, proceeding exposure and photographing using an LED lamp, a metal halide lamp or the like in an air atmosphere, LED lamp, metal halide or the like. At this time, the photopolymerizable composition may be applied in the form of a single film and then photocured to form an optical member in the form of a general optical film, and if necessary, it can be applied so as to have a certain pattern using the inkjet equipment and then photocured. In this case, the optical member may be in the form of a patterned film in which a cured film patterned in a form of polyhedron such as a prism structure is formed on a substrate.

The above-mentioned optical member such as an optical film or a patterned film may have a general thickness depending on the type or structure of the applied display device. For example, it may have a thickness adjusted within the range of 0.01 μm to 1000 μm.

Further, the optical member may have a sensitivity value of 3 J or less, and a light transmittance of 90% or more. The sensitivity can be measured by comparing absorbance measurement results before and after exposure using an FT-IR spectrophotometer. More specifically, the conversion rate is obtained by integrating the C═O peak of 1650 to 1750 cm¹ and the C═C peak of 780 to 880 cm⁻¹, and the sensitivity may mean an exposure amount that is saturated at a conversion rate of 80% or more. Further, the light transmittance may mean an average transmittance measured at a wavelength of 380 to 780 nm using a JV-VIS spectrophotometer for an optical member such as an optical film.

The optical film may have a 5 wt. % loss temperature measured by TGA by increasing the temperature from room temperature to 900° C. at a rate of 10° C. per minute to be 270° C. or more, thereby exhibiting excellent heat resistance.

Since the above-mentioned optical member of another embodiment, such as the optical film or pattern film satisfies excellent optical properties, heat resistance, mechanical properties, and the like, it can be applied to various display devices and greatly contribute to the improvement of its characteristics.

Therefore, according to yet another embodiment of the present disclosure, a display device including the optical member cured from the photopolymerizable composition according to the present disclosure is provided.

The configuration of the display device to which the optical member such as the optical film or the pattern film is applied can follow a conventional configuration well known in the art, except that the optical member of the other embodiments described above is applied, and therefore, an additional description thereof will be omitted.

Hereinafter, examples are presented to facilitate the understanding of the present disclosure. However, the following examples are for illustrative purposes only and the present disclosure is not limited thereto.

### Examples 1 to 309, Comparative Examples 1 to 44, and Reference Examples 1 to 9

Preparation of Photopolymerizable Composition and Optical Film

First, the monomers and components shown in Tables 1 to 5 below were used as the components used in the preparation of the photopolymerizable compositions of Examples, Comparative Examples and Reference Examples.

TABLE 1

| | High refractive index monomer |
|---|---|
| 1 | Benzyl acrylate |
| 2 | Phenoxyethyl acrylate |
| 3 | Phenoxybenzyl acrylate |
| 4 | Biphenyl methyl acrylate |
| 5 | O-phenylphenoxyethyl acrylate |
| 6 | Chemical Formula 1 (R = H) |
| 7 | Chemical Formula 1 (R = CH₃) |
| 8 | Chemical Formula 2 (R = H) |
| 9 | Chemical Formula 2 (R = CH₃) |
| 10 | Chemical Formula 3 (R = H) |
| 11 | Chemical Formula 3 (R = CH₃) |
| 12 | Chemical Formula 4 (R = H) |
| 13 | Chemical Formula 4 (R = CH₃)) |
| 14 | Chemical Formula 5 (R = H) |
| 15 | Chemical Formula 5 (R = CH₃) |
| 16 | Chemical Formula 6 (R = H) |
| 17 | Chemical Formula 6 (R = CH₃)) |
| 18 | Chemical Formula 7 (R = H) |
| 19 | Chemical Formula 7 (R = CH₃) |

TABLE 2

| | Highly flexible monomer |
|---|---|
| 1 | Isodecyl acrylate |
| 2 | Lauryl acrylate |
| 3 | Stearyl acrylate |
| 4 | Ethoxy ethyl acrylate |
| 5 | Ethoxy ethoxy ethyl acrylate |
| 6 | Triethylene glycol diacrylate |
| 7 | Tetraethylene glycol diacrylate |
| 8 | Dipropylene glycol diacrylate |
| 9 | Tripropylene glycol diacrylate |
| 10 | Chemical Formula 8 (a, b = 0) |
| 11 | Chemical Formula 8 (a, b = 2) |
| 12 | (a + b > 10) in Chemical Formula 8 |

TABLE 3

| | Photoinitiator |
|---|---|
| 1 | [1-[9-ethyl-6-(2-methylbenzoyl)-9H-carbazoyl-3-yl]-1-(O-acetyloxime) |
| 2 | OXE-01 |
| 3 | OXE-04 |
| 4 | Darocure TPO |
| 5 | (E)-2-(acetoxyimino)-1-(9,9-diethyl-9H-fluorene-2-yl) butanone |
| 6 | Irgacure 819 |
| 7 | Irgacure 369 |
| 8 | Irgacure 907 |

TABLE 4

| | Amine synergist |
|---|---|
| 1 | Ethyl dimethylamino benzoate |
| 2 | Butoxyethyl dimethylamino benzoate |
| 3 | Diethylaminoethyl (meth)acrylate |
| 4 | P115 (manufactured by SK Cytec) |
| 5 | MIRAMER AS2010(manufactured by Miwon Specialty Chemical |
| | Co., Ltd.) |
| 6 | MIRAMER AS5142(manufactured by Miwon Specialty Chemical |
| | Co., Ltd.) |

TABLE 5

| | Photosensitizer |
|---|---|
| 1 | Isopropyl thioxanthone |
| 2 | 9,10-dibutoxyanthracene |
| 3 | 9,10-diethoxyanthracene |
| 4 | 3,7-dimethoxyanthracene |

Then, each component was mixed with the compositions of Tables 6 to 14 below to prepare the photopolymerizable compositions of Examples and Comparative Examples. In Tables 6 to 14, each content unit represents a part by weight.

Each photopolymerizable composition was put into inkjet equipment, and then applied to a bare glass to form a single film having a thickness of 20 jam.

Then, the single film was irradiated with an exposure amount of 1.5 J/cm² using an LED 385 nm curing device, thereby preparing an optical film including a cured film of a photopolymerizable composition. This coating film (thickness: 20 μm) was provided as an optical film. However, in the case of refractive index measurement, spin coating was performed to provide a 2 μn coating film.

TABLE 6

| | High refractive | | Highly flexible | | |
|---|---|---|---|---|---|
| | index monomer 1 | | monomer 1 | | Photoinitiator |
| Category | Type | Content | Type | Content | 1 |
| Example 1 | 1 | 90 | 1 | 10 | 0.5 |
| Example 2 | 1 | 80 | 2 | 20 | 1 |
| Example 3 | 1 | 70 | 3 | 30 | 5 |
| Example 4 | 1 | 60 | 4 | 40 | 8 |
| Example 5 | 1 | 50 | 5 | 50 | 10 |
| Example 6 | 1 | 40 | 6 | 60 | 15 |
| Example 7 | 1 | 30 | 7 | 70 | 20 |
| Example 8 | 1 | 20 | 8 | 80 | 25 |
| Example 9 | 1 | 10 | 9 | 90 | 30 |
| Example 10 | 2 | 90 | 10 | 10 | 0.5 |
| Example 11 | 2 | 80 | 11 | 20 | 1 |
| Example 12 | 2 | 70 | 1 | 30 | 5 |
| Example 13 | 2 | 60 | 2 | 40 | 8 |
| Example 14 | 2 | 50 | 3 | 50 | 10 |
| Example 15 | 2 | 40 | 4 | 60 | 15 |
| Example 16 | 2 | 30 | 5 | 70 | 20 |
| Example 17 | 2 | 20 | 6 | 80 | 25 |
| Example 18 | 2 | 10 | 7 | 90 | 30 |
| Example 19 | 3 | 90 | 8 | 10 | 0.5 |
| Example 20 | 3 | 80 | 9 | 20 | 1 |
| Example 21 | 3 | 70 | 10 | 30 | 5 |
| Example 22 | 3 | 60 | 11 | 40 | 8 |
| Example 23 | 3 | 50 | 1 | 50 | 10 |
| Example 24 | 3 | 40 | 2 | 60 | 15 |
| Example 25 | 3 | 30 | 3 | 70 | 20 |
| Example 26 | 3 | 20 | 4 | 80 | 25 |
| Example 27 | 3 | 10 | 5 | 90 | 30 |
| Example 28 | 4 | 90 | 6 | 10 | 0.5 |
| Example 29 | 4 | 80 | 7 | 20 | 1 |
| Example 30 | 4 | 70 | 8 | 30 | 5 |
| Example 31 | 4 | 60 | 9 | 40 | 8 |
| Example 32 | 4 | 50 | 10 | 50 | 10 |
| Example 33 | 4 | 40 | 11 | 60 | 15 |
| Example 34 | 4 | 30 | 1 | 70 | 20 |
| Example 35 | 4 | 20 | 2 | 80 | 25 |
| Example 36 | 4 | 10 | 3 | 90 | 30 |
| Example 37 | 5 | 90 | 4 | 10 | 0.5 |
| Example 38 | 5 | 80 | 5 | 20 | 1 |
| Example 39 | 5 | 70 | 6 | 30 | 5 |
| Example 40 | 5 | 60 | 7 | 40 | 8 |
| Example 41 | 5 | 50 | 8 | 50 | 10 |
| Example 42 | 5 | 40 | 9 | 60 | 15 |
| Example 43 | 5 | 30 | 10 | 70 | 20 |
| Example 44 | 5 | 20 | 11 | 80 | 25 |
| Example 45 | 5 | 10 | 1 | 90 | 30 |
| Example 46 | 6 | 90 | 2 | 10 | 0.5 |
| Example 47 | 6 | 80 | 3 | 20 | 1 |
| Example 48 | 6 | 70 | 4 | 30 | 5 |
| Example 49 | 6 | 60 | 5 | 40 | 8 |
| Example 50 | 6 | 50 | 6 | 50 | 10 |

TABLE 7

| | High refractive | | Highly flexible | | |
|---|---|---|---|---|---|
| | index monomer 1 | | monomer 1 | | Photoinitiator |
| Category | Type | Content | Type | Content | 1 |
| Example 51 | 6 | 40 | 7 | 60 | 15 |
| Example 52 | 6 | 30 | 8 | 70 | 20 |
| Example 53 | 6 | 20 | 9 | 80 | 25 |
| Example 54 | 6 | 10 | 10 | 90 | 30 |
| Example 55 | 7 | 90 | 11 | 10 | 0.5 |
| Example 56 | 7 | 80 | 1 | 20 | 1 |
| Example 57 | 7 | 70 | 2 | 30 | 5 |
| Example 58 | 7 | 60 | 3 | 40 | 8 |
| Example 59 | 7 | 50 | 4 | 50 | 10 |
| Example 60 | 7 | 40 | 5 | 60 | 15 |
| Example 61 | 7 | 30 | 6 | 70 | 20 |
| Example 62 | 7 | 20 | 7 | 80 | 25 |
| Example 63 | 7 | 10 | 8 | 90 | 30 |
| Example 64 | 8 | 90 | 9 | 10 | 0.5 |
| Example 65 | 8 | 80 | 10 | 20 | 1 |
| Example 66 | 8 | 70 | 11 | 30 | 5 |
| Example 67 | 8 | 60 | 1 | 40 | 8 |
| Example 68 | 8 | 50 | 2 | 50 | 10 |
| Example 69 | 8 | 40 | 3 | 60 | 15 |
| Example 70 | 8 | 30 | 4 | 70 | 20 |
| Example 71 | 8 | 20 | 5 | 80 | 25 |
| Example 72 | 8 | 10 | 6 | 90 | 30 |
| Example 73 | 9 | 90 | 7 | 10 | 0.5 |
| Example 74 | 9 | 80 | 8 | 20 | 1 |
| Example 75 | 9 | 70 | 9 | 30 | 5 |
| Example 76 | 9 | 60 | 10 | 40 | 8 |
| Example 77 | 9 | 50 | 11 | 50 | 10 |
| Example 78 | 9 | 40 | 1 | 60 | 15 |
| Example 79 | 9 | 30 | 2 | 70 | 20 |
| Example 80 | 9 | 20 | 3 | 80 | 25 |
| Example 81 | 9 | 10 | 4 | 90 | 30 |
| Example 82 | 10 | 90 | 5 | 10 | 0.5 |
| Example 83 | 10 | 80 | 6 | 20 | 1 |
| Example 84 | 10 | 70 | 7 | 30 | 5 |
| Example 85 | 10 | 60 | 8 | 40 | 8 |
| Example 86 | 10 | 50 | 9 | 50 | 10 |
| Example 87 | 10 | 40 | 10 | 60 | 15 |
| Example 88 | 10 | 30 | 11 | 70 | 20 |
| Example 89 | 10 | 20 | 1 | 80 | 25 |
| Example 90 | 10 | 10 | 2 | 90 | 30 |
| Example 91 | 11 | 90 | 3 | 10 | 0.5 |
| Example 92 | 11 | 80 | 4 | 20 | 1 |
| Example 93 | 11 | 70 | 5 | 30 | 5 |
| Example 94 | 11 | 60 | 6 | 40 | 8 |
| Example 95 | 11 | 50 | 7 | 50 | 10 |
| Example 96 | 11 | 40 | 8 | 60 | 15 |
| Example 97 | 11 | 30 | 9 | 70 | 20 |
| Example 98 | 11 | 20 | 10 | 80 | 25 |
| Example 99 | 11 | 10 | 11 | 90 | 30 |
| Example 100 | 12 | 90 | 1 | 10 | 0.5 |

TABLE 8

| | High refractive | | Highly flexible | | |
|---|---|---|---|---|---|
| | index monomer 1 | | monomer 1 | | Photoinitiator |
| Category | Type | Content | Type | Content | 1 |
| Example 101 | 12 | 80 | 2 | 20 | 1 |
| Example 102 | 12 | 70 | 3 | 30 | 5 |
| Example 103 | 12 | 60 | 4 | 40 | 8 |
| Example 104 | 12 | 50 | 5 | 50 | 10 |
| Example 105 | 12 | 40 | 6 | 60 | 15 |
| Example 106 | 12 | 30 | 7 | 70 | 20 |
| Example 107 | 12 | 20 | 8 | 80 | 25 |
| Example 108 | 12 | 10 | 9 | 90 | 30 |
| Example 109 | 13 | 90 | 10 | 10 | 0.5 |
| Example 110 | 13 | 80 | 11 | 20 | 1 |
| Example 111 | 13 | 70 | 1 | 30 | 5 |
| Example 112 | 13 | 60 | 2 | 40 | 8 |
| Example 113 | 13 | 50 | 3 | 50 | 10 |
| Example 114 | 13 | 40 | 4 | 60 | 15 |
| Example 115 | 13 | 30 | 5 | 70 | 20 |
| Example 116 | 13 | 20 | 6 | 80 | 25 |
| Example 117 | 13 | 10 | 7 | 90 | 30 |
| Example 118 | 14 | 90 | 8 | 10 | 0.5 |
| Example 119 | 14 | 80 | 9 | 20 | 1 |
| Example 120 | 14 | 70 | 10 | 30 | 5 |
| Example 121 | 14 | 60 | 11 | 40 | 8 |
| Example 122 | 14 | 50 | 1 | 50 | 10 |
| Example 123 | 14 | 40 | 2 | 60 | 15 |
| Example 124 | 14 | 30 | 3 | 70 | 20 |
| Example 125 | 14 | 20 | 4 | 80 | 25 |
| Example 126 | 14 | 10 | 5 | 90 | 30 |
| Example 127 | 15 | 90 | 6 | 10 | 0.5 |
| Example 128 | 15 | 80 | 7 | 20 | 1 |
| Example 129 | 15 | 70 | 8 | 30 | 5 |
| Example 130 | 15 | 60 | 9 | 40 | 8 |
| Example 131 | 15 | 50 | 10 | 50 | 10 |
| Example 132 | 15 | 40 | 11 | 60 | 15 |
| Example 133 | 15 | 30 | 1 | 70 | 20 |
| Example 134 | 15 | 20 | 2 | 80 | 25 |
| Example 135 | 15 | 10 | 3 | 90 | 30 |
| Example 136 | 16 | 90 | 4 | 10 | 0.5 |
| Example 137 | 16 | 80 | 5 | 20 | 1 |
| Example 138 | 16 | 70 | 6 | 30 | 5 |
| Example 139 | 16 | 60 | 7 | 40 | 8 |
| Example 140 | 16 | 50 | 8 | 50 | 10 |
| Example 141 | 16 | 40 | 9 | 60 | 15 |
| Example 142 | 16 | 30 | 10 | 70 | 20 |
| Example 143 | 16 | 20 | 11 | 80 | 25 |
| Example 144 | 16 | 10 | 1 | 90 | 30 |
| Example 145 | 17 | 90 | 2 | 10 | 0.5 |
| Example 146 | 17 | 80 | 3 | 20 | 1 |
| Example 147 | 17 | 70 | 4 | 30 | 5 |
| Example 148 | 17 | 60 | 5 | 40 | 8 |
| Example 149 | 17 | 50 | 6 | 50 | 10 |
| Example 150 | 17 | 40 | 7 | 60 | 15 |

TABLE 9

| | High refractive index | | Highly flexible | | | | | | | | | | Photo- | Amine |
|---|---|---|---|---|---|---|---|---|---|---|---|---|---|---|
| | monomer 1 | | monomer 1 | | Photoinitiator | | | | | | | | sensitizer | synergist |
| Category | Type | Content | Type | Content | 1 | 2 | 3 | 4 | 5 | 6 | 7 | 8 | 1 | 1 |
| Example | 17 | 30 | 8 | 70 | 20 | | | | | | | | | |
| 151 | | | | | | | | | | | | | | |
| Example | 17 | 20 | 9 | 80 | 25 | | | | | | | | | |
| 152 | | | | | | | | | | | | | | |
| Example | 17 | 10 | 10 | 90 | 30 | | | | | | | | | |
| 153 | | | | | | | | | | | | | | |
| Example | 18 | 90 | 11 | 10 | 0.5 | | | | | | | | | |
| 154 | | | | | | | | | | | | | | |
| Example | 18 | 80 | 1 | 20 | 1 | | | | | | | | | |
| 155 | | | | | | | | | | | | | | |
| Example | 18 | 70 | 2 | 30 | 5 | | | | | | | | | |
| 156 | | | | | | | | | | | | | | |
| Example | 18 | 60 | 3 | 40 | 8 | | | | | | | | | |
| 157 | | | | | | | | | | | | | | |
| Example | 18 | 50 | 4 | 50 | 10 | | | | | | | | | |
| 158 | | | | | | | | | | | | | | |
| Example | 18 | 40 | 5 | 60 | 15 | | | | | | | | | |
| 159 | | | | | | | | | | | | | | |
| Example | 18 | 30 | 6 | 70 | 20 | | | | | | | | | |
| 160 | | | | | | | | | | | | | | |
| Example | 18 | 20 | 7 | 80 | 25 | | | | | | | | | |
| 161 | | | | | | | | | | | | | | |
| Example | 18 | 10 | 8 | 90 | 30 | | | | | | | | | |
| 162 | | | | | | | | | | | | | | |
| Example | 19 | 90 | 9 | 10 | 0.5 | | | | | | | | | |
| 163 | | | | | | | | | | | | | | |
| Example | 19 | 80 | 10 | 20 | 1 | | | | | | | | | |
| 164 | | | | | | | | | | | | | | |
| Example | 19 | 70 | 11 | 30 | 5 | | | | | | | | | |
| 165 | | | | | | | | | | | | | | |
| Example | 19 | 60 | 1 | 40 | 8 | | | | | | | | | |
| 166 | | | | | | | | | | | | | | |
| Example | 19 | 50 | 2 | 50 | 10 | | | | | | | | | |
| 167 | | | | | | | | | | | | | | |
| Example | 19 | 40 | 3 | 60 | 15 | | | | | | | | | |
| 168 | | | | | | | | | | | | | | |
| Example | 19 | 30 | 4 | 70 | 20 | | | | | | | | | |
| 169 | | | | | | | | | | | | | | |
| Example | 19 | 20 | 5 | 80 | 25 | | | | | | | | | |
| 170 | | | | | | | | | | | | | | |
| Example | 19 | 10 | 6 | 90 | 30 | | | | | | | | | |
| 171 | | | | | | | | | | | | | | |
| Example | 3 | 60 | 4 | 40 | 0.5 | | | | | | | | 3 | |
| 172 | | | | | | | | | | | | | | |
| Example | 3 | 60 | 4 | 40 | 1 | | | | | | | | 3 | |
| 173 | | | | | | | | | | | | | | |
| Example | 3 | 60 | 4 | 40 | 5 | | | | | | | | 3 | |
| 174 | | | | | | | | | | | | | | |
| Example | 3 | 60 | 4 | 40 | 10 | | | | | | | | 3 | |
| 175 | | | | | | | | | | | | | | |
| Example | 3 | 60 | 4 | 40 | 15 | | | | | | | | 3 | |
| 176 | | | | | | | | | | | | | | |
| Example | 3 | 60 | 4 | 40 | 30 | | | | | | | | 3 | |
| 177 | | | | | | | | | | | | | | |
| Example | 3 | 60 | 4 | 40 | 0.5 | | | | | | | | | 3 |
| 178 | | | | | | | | | | | | | | |
| Example | 3 | 60 | 4 | 40 | 1 | | | | | | | | | 3 |
| 179 | | | | | | | | | | | | | | |
| Example | 3 | 60 | 4 | 40 | 5 | | | | | | | | | 3 |
| 180 | | | | | | | | | | | | | | |
| Example | 3 | 60 | 4 | 40 | 10 | | | | | | | | | 3 |
| 181 | | | | | | | | | | | | | | |
| Example | 3 | 60 | 4 | 40 | 15 | | | | | | | | | 3 |
| 182 | | | | | | | | | | | | | | |
| Example | 3 | 60 | 4 | 40 | 30 | | | | | | | | | 3 |
| 183 | | | | | | | | | | | | | | |
| Example | 3 | 60 | 4 | 40 | 0.5 | | | | | | | | 3 | 3 |
| 184 | | | | | | | | | | | | | | |
| Example | 3 | 60 | 4 | 40 | 1 | | | | | | | | 3 | 3 |
| 185 | | | | | | | | | | | | | | |
| Example | 3 | 60 | 4 | 40 | 5 | | | | | | | | 3 | 3 |
| 186 | | | | | | | | | | | | | | |
| Example | 3 | 60 | 4 | 40 | 10 | | | | | | | | 3 | 3 |
| 187 | | | | | | | | | | | | | | |
| Example | 3 | 60 | 4 | 40 | 15 | | | | | | | | 3 | 3 |
| 188 | | | | | | | | | | | | | | |
| Example | 3 | 60 | 4 | 40 | 30 | | | | | | | | 3 | 3 |
| 189 | | | | | | | | | | | | | | |
| Example | 3 | 60 | 6 | 40 | 8 | | | | | | | | 0.1 | |
| 190 | | | | | | | | | | | | | | |
| Example | 3 | 60 | 6 | 40 | 8 | | | | | | | | 1 | |
| 191 | | | | | | | | | | | | | | |
| Example | 3 | 60 | 6 | 40 | 8 | | | | | | | | 5 | |
| 192 | | | | | | | | | | | | | | |
| Example | 3 | 60 | 6 | 40 | 8 | | | | | | | | 10 | |
| 193 | | | | | | | | | | | | | | |
| Example | 3 | 60 | 6 | 40 | 8 | | | | | | | | | 0.1 |
| 194 | | | | | | | | | | | | | | |
| Example | 3 | 60 | 6 | 40 | 8 | | | | | | | | | 1 |
| 194-1 | | | | | | | | | | | | | | |
| Example | 3 | 60 | 6 | 40 | 8 | | | | | | | | | 5 |
| 194-2 | | | | | | | | | | | | | | |
| Example | 3 | 60 | 6 | 40 | 8 | | | | | | | | | 10 |
| 195 | | | | | | | | | | | | | | |
| Example | 3 | 60 | 6 | 40 | | 8 | | | | | | | | |
| 196 | | | | | | | | | | | | | | |
| Example | 3 | 60 | 6 | 40 | | | 8 | | | | | | | |
| 197 | | | | | | | | | | | | | | |
| Example | 3 | 60 | 6 | 40 | | | | 8 | | | | | | |
| 198 | | | | | | | | | | | | | | |
| Example | 3 | 60 | 6 | 40 | | | | | 8 | | | | | |
| 199 | | | | | | | | | | | | | | |
| Example | 3 | 60 | 6 | 40 | | | | | | 8 | | | | |
| 200 | | | | | | | | | | | | | | |
| Example | 3 | 60 | 6 | 40 | | | | | | 8 | | | | |
| 201 | | | | | | | | | | | | | | |
| Example | 3 | 60 | 6 | 40 | | | | | | 8 | | | | |
| 202 | | | | | | | | | | | | | | |

TABLE 10

| | High refractive | | Highly flexible | | | | | | | | | | Photo- | | | Amine | | | | |
|---|---|---|---|---|---|---|---|---|---|---|---|---|---|---|---|---|---|---|---|---|
| | index monomer 1 | | monomer 1 | | Photoinitiator | | | | | | | | sensitizer | | | synergist | | | | |
| Category | Type | Content | Type | Content | 1 | 2 | 3 | 4 | 5 | 6 | 7 | 8 | 2 | 3 | 4 | 2 | 3 | 4 | 5 | 6 |
| Example | 3 | 60 | 6 | 40 | 8 | | | | | | | | 3 | | | | | | | |
| 203 | | | | | | | | | | | | | | | | | | | | |
| Example | 3 | 60 | 6 | 40 | 8 | | | | | | | | | 3 | | | | | | |
| 204 | | | | | | | | | | | | | | | | | | | | |
| Example | 3 | 60 | 6 | 40 | 8 | | | | | | | | | | 3 | | | | | |
| 205 | | | | | | | | | | | | | | | | | | | | |
| Example | 3 | 60 | 6 | 40 | 8 | | | | | | | | | | | 3 | | | | |
| 206 | | | | | | | | | | | | | | | | | | | | |
| Example | 3 | 60 | 6 | 40 | 8 | | | | | | | | | | | | 3 | | | |
| 207 | | | | | | | | | | | | | | | | | | | | |
| Example | 3 | 60 | 6 | 40 | 8 | | | | | | | | | | | | | 3 | | |
| 208 | | | | | | | | | | | | | | | | | | | | |
| Example | 3 | 60 | 6 | 40 | 8 | | | | | | | | | | | | | | 3 | |
| 209 | | | | | | | | | | | | | | | | | | | | |
| Example | 3 | 60 | 6 | 40 | 8 | | | | | | | | | | | | | | | 3 |
| 210 | | | | | | | | | | | | | | | | | | | | |
| Example | 3 | 60 | 6 | 40 | 8 | | | | | | | | 3 | | | 3 | | | | |
| 211 | | | | | | | | | | | | | | | | | | | | |
| Example | 3 | 60 | 6 | 40 | 8 | | | | | | | | 3 | | | | 3 | | | |
| 212 | | | | | | | | | | | | | | | | | | | | |
| Example | 3 | 60 | 6 | 40 | 8 | | | | | | | | 3 | | | | | 3 | | |
| 213 | | | | | | | | | | | | | | | | | | | | |
| Example | 3 | 60 | 6 | 40 | 8 | | | | | | | | 3 | | | | | | 3 | |
| 214 | | | | | | | | | | | | | | | | | | | | |
| Example | 3 | 60 | 6 | 40 | 8 | | | | | | | | 3 | | | | | | | 3 |
| 215 | | | | | | | | | | | | | | | | | | | | |
| Example | 3 | 60 | 6 | 40 | | 8 | | | | | | | | 3 | | 3 | | | | |
| 216 | | | | | | | | | | | | | | | | | | | | |
| Example | 3 | 60 | 6 | 40 | | | 8 | | | | | | | 3 | | | 3 | | | |
| 217 | | | | | | | | | | | | | | | | | | | | |
| Example | 3 | 60 | 6 | 40 | | | | 8 | | | | | | 3 | | | | 3 | | |
| 218 | | | | | | | | | | | | | | | | | | | | |
| Example | 3 | 60 | 6 | 40 | | | | | 8 | | | | | 3 | | | | | 3 | |
| 219 | | | | | | | | | | | | | | | | | | | | |
| Example | 3 | 60 | 6 | 40 | | | | | | 8 | | | | 3 | | | | | | 3 |
| 220 | | | | | | | | | | | | | | | | | | | | |
| Example | 3 | 60 | 6 | 40 | | | | | | | 8 | | | | 3 | 3 | | | | |
| 221 | | | | | | | | | | | | | | | | | | | | |
| Example | 3 | 60 | 6 | 40 | | | | | | | | 8 | | | 3 | | 3 | | | |
| 222 | | | | | | | | | | | | | | | | | | | | |
| Example | 3 | 60 | 6 | 40 | 8 | | | | | | | | | | 3 | | | 3 | | |
| 223 | | | | | | | | | | | | | | | | | | | | |
| Example | 3 | 60 | 6 | 40 | 8 | | | | | | | | | | 3 | | | | 3 | |
| 224 | | | | | | | | | | | | | | | | | | | | |
| Example | 3 | 60 | 6 | 40 | 8 | | | | | | | | | | 3 | | | | | 3 |
| 225 | | | | | | | | | | | | | | | | | | | | |

TABLE 11

| | High refractive index | | High refractive index | | Highly flexible | | Highly flexible | | |
|---|---|---|---|---|---|---|---|---|---|
| | monomer 1 | | monomer 2 | | monomer 1 | | monomer 2 | | Photoinitiator |
| Category | Type | Content | Type | Content | Type | Content | Type | Content | 1 |
| Example | 4 | 30 | 10 | 30 | 4 | 40 | | | 0.5 |
| 226 | | | | | | | | | |
| Example | 4 | 40 | 10 | 20 | 4 | 40 | | | 1 |
| 227 | | | | | | | | | |
| Example | 4 | 50 | 10 | 10 | 4 | 40 | | | 5 |
| 228 | | | | | | | | | |
| Example | 4 | 30 | 13 | 30 | 4 | 40 | | | 10 |
| 229 | | | | | | | | | |
| Example | 4 | 40 | 13 | 20 | 4 | 40 | | | 15 |
| 230 | | | | | | | | | |
| Example | 4 | 50 | 13 | 10 | 4 | 40 | | | 30 |
| 231 | | | | | | | | | |
| Example | 4 | 55 | 13 | 5 | 4 | 40 | | | 0.5 |
| 232 | | | | | | | | | |
| Example | 5 | 30 | 15 | 30 | 4 | 40 | | | 1 |
| 233 | | | | | | | | | |
| Example | 5 | 40 | 15 | 20 | 4 | 40 | | | 5 |
| 234 | | | | | | | | | |
| Example | 5 | 50 | 15 | 10 | 4 | 40 | | | 10 |
| 235 | | | | | | | | | |
| Example | 5 | 55 | 15 | 5 | 4 | 40 | | | 15 |
| 236 | | | | | | | | | |
| Example | 5 | 30 | 15 | 30 | 5 | 15 | 11 | 25 | 30 |
| 237 | | | | | | | | | |
| Example | 5 | 40 | 15 | 20 | 5 | 20 | 11 | 20 | 0.5 |
| 238 | | | | | | | | | |
| Example | 5 | 50 | 15 | 10 | 5 | 25 | 11 | 15 | 1 |
| 239 | | | | | | | | | |
| Example | 5 | 55 | 15 | 5 | 5 | 30 | 11 | 10 | 5 |
| 240 | | | | | | | | | |
| Example | 3 | 60 | | | 5 | 15 | 11 | 25 | 10 |
| 241 | | | | | | | | | |
| Example | 3 | 60 | | | 5 | 20 | 11 | 20 | 15 |
| 242 | | | | | | | | | |
| Example | 3 | 60 | | | 5 | 25 | 11 | 15 | 30 |
| 243 | | | | | | | | | |
| Example | 3 | 60 | | | 5 | 30 | 11 | 10 | 5 |
| 244 | | | | | | | | | |

TABLE 12

| | High refractive | | | | | | | | | | |
|---|---|---|---|---|---|---|---|---|---|---|---|
| | index | | High refractive | | Highly flexible | | Highly flexible | | | | Amine |
| | monomer 1 | | index monomer 2 | | monomer 1 | | monomer 2 | | Photoinitiator | Photosensitizer | synergist |
| Category | Type | Content | Type | Content | Type | Content | Type | Content | 1 | 1 | 1 |
| Example | 1 | 70 | | | 1 | 30 | | | 5 | 3 | 5 |
| 245 | | | | | | | | | | | |
| Example | 2 | 70 | | | 1 | 30 | | | 5 | 3 | 5 |
| 246 | | | | | | | | | | | |
| Example | 3 | 70 | | | 1 | 30 | | | 5 | 3 | 5 |
| 247 | | | | | | | | | | | |
| Example | 4 | 70 | | | 1 | 30 | | | 5 | 3 | 5 |
| 248 | | | | | | | | | | | |
| Example | 5 | 70 | | | 1 | 30 | | | 5 | 3 | 5 |
| 249 | | | | | | | | | | | |
| Example | 6 | 70 | | | 1 | 30 | | | 5 | 3 | 5 |
| 250 | | | | | | | | | | | |
| Example | 7 | 70 | | | 1 | 30 | | | 5 | 3 | 5 |
| 251 | | | | | | | | | | | |
| Example | 8 | 70 | | | 1 | 30 | | | 5 | 3 | 5 |
| 252 | | | | | | | | | | | |
| Example | 9 | 70 | | | 1 | 30 | | | 5 | 3 | 5 |
| 253 | | | | | | | | | | | |
| Example | 4 | 10 | | | 1 | 90 | | | 5 | 3 | 5 |
| 254 | | | | | | | | | | | |
| Example | 4 | 30 | | | 1 | 70 | | | 5 | 3 | 5 |
| 255 | | | | | | | | | | | |
| Example | 4 | 50 | | | 1 | 50 | | | 5 | 3 | 5 |
| 256 | | | | | | | | | | | |
| Example | 4 | 60 | | | 1 | 40 | | | 5 | 3 | 5 |
| 257 | | | | | | | | | | | |
| Example | 4 | 80 | | | 1 | 20 | | | 5 | 3 | 5 |
| 258 | | | | | | | | | | | |
| Example | 4 | 90 | | | 1 | 10 | | | 5 | 3 | 5 |
| 259 | | | | | | | | | | | |
| Example | 4 | 70 | | | 2 | 30 | | | 5 | 3 | 5 |
| 260 | | | | | | | | | | | |
| Example | 4 | 70 | | | 3 | 30 | | | 5 | 3 | 5 |
| 261 | | | | | | | | | | | |
| Example | 4 | 70 | | | 4 | 30 | | | 5 | 3 | 5 |
| 262 | | | | | | | | | | | |
| Example | 4 | 70 | | | 5 | 30 | | | 5 | 3 | 5 |
| 263 | | | | | | | | | | | |
| Example | 4 | 70 | | | 6 | 30 | | | 5 | 3 | 5 |
| 264 | | | | | | | | | | | |
| Example | 4 | 70 | | | 7 | 30 | | | 5 | 3 | 5 |
| 265 | | | | | | | | | | | |
| Example | 4 | 70 | | | 8 | 30 | | | 5 | 3 | 5 |
| 266 | | | | | | | | | | | |
| Example | 4 | 70 | | | 9 | 30 | | | 5 | 3 | 5 |
| 267 | | | | | | | | | | | |
| Example | 4 | 70 | | | 10 | 30 | | | 5 | 3 | 5 |
| 268 | | | | | | | | | | | |
| Example | 4 | 70 | | | 11 | 30 | | | 5 | 3 | 5 |
| 269 | | | | | | | | | | | |
| Example | 4 | 55 | 6 | 15 | 1 | 30 | | | 5 | 3 | 5 |
| 270 | | | | | | | | | | | |
| Example | 4 | 40 | 6 | 30 | 1 | 30 | | | 5 | 3 | 5 |
| 271 | | | | | | | | | | | |
| Example | 4 | 55 | 7 | 15 | 1 | 30 | | | 5 | 3 | 5 |
| 272 | | | | | | | | | | | |
| Example | 4 | 40 | 7 | 30 | 1 | 30 | | | 5 | 3 | 5 |
| 273 | | | | | | | | | | | |
| Example | 4 | 55 | 8 | 15 | 1 | 30 | | | 5 | 3 | 5 |
| 274 | | | | | | | | | | | |
| Example | 4 | 40 | 8 | 30 | 1 | 30 | | | 5 | 3 | 5 |
| 275 | | | | | | | | | | | |
| Example | 4 | 55 | 9 | 15 | 1 | 30 | | | 5 | 3 | 5 |
| 276 | | | | | | | | | | | |
| Example | 4 | 40 | 9 | 30 | 1 | 30 | | | 5 | 3 | 5 |
| 277 | | | | | | | | | | | |
| Example | 4 | 70 | | | 1 | 15 | 3 | 15 | 5 | 3 | 5 |
| 278 | | | | | | | | | | | |
| Example | 4 | 70 | | | 1 | 20 | 3 | 10 | 5 | 3 | 5 |
| 279 | | | | | | | | | | | |
| Example | 4 | 70 | | | 5 | 15 | 10 | 15 | 5 | 3 | 5 |
| 280 | | | | | | | | | | | |
| Example | 4 | 70 | | | 5 | 20 | 10 | 10 | 5 | 3 | 5 |
| 281 | | | | | | | | | | | |

TABLE 13

| | High | | Highly | | | | | | | | | | | | | | | | | | | |
|---|---|---|---|---|---|---|---|---|---|---|---|---|---|---|---|---|---|---|---|---|---|---|
| | refractive index | | flexible | | | | | | | | | | | | | | | | | | | |
| | monomer 1 | | monomer 1 | | Photoinitiator | | | | | | | | Photosensitizer | | | | Amine synergist | | | | | |
| Category | Type | Content | Type | Content | 1 | 2 | 3 | 4 | 5 | 6 | 7 | 8 | 1 | 2 | 3 | 4 | 1 | 2 | 3 | 4 | 5 | 6 |
| Example | 4 | 70 | 1 | 30 | | 5 | | | | | | | 3 | | | | 5 | | | | | |
| 282 | | | | | | | | | | | | | | | | | | | | | | |
| Example | 4 | 70 | 1 | 30 | | | 5 | | | | | | 3 | | | | 5 | | | | | |
| 283 | | | | | | | | | | | | | | | | | | | | | | |
| Example | 4 | 70 | 1 | 30 | | | | 5 | | | | | 3 | | | | 5 | | | | | |
| 284 | | | | | | | | | | | | | | | | | | | | | | |
| Example | 4 | 70 | 1 | 30 | | | | | 5 | | | | 3 | | | | 5 | | | | | |
| 285 | | | | | | | | | | | | | | | | | | | | | | |
| Example | 4 | 70 | 1 | 30 | | | | | | 5 | | | 3 | | | | 5 | | | | | |
| 286 | | | | | | | | | | | | | | | | | | | | | | |
| Example | 4 | 70 | 1 | 30 | | | | | | | 5 | | 3 | | | | 5 | | | | | |
| 287 | | | | | | | | | | | | | | | | | | | | | | |
| Example | 4 | 70 | 1 | 30 | | | | | | | | 5 | 3 | | | | 5 | | | | | |
| 288 | | | | | | | | | | | | | | | | | | | | | | |
| Example | 4 | 70 | 1 | 30 | 5 | | | | | | | | | 3 | | | 5 | | | | | |
| 289 | | | | | | | | | | | | | | | | | | | | | | |
| Example | 4 | 70 | 1 | 30 | 5 | | | | | | | | | | 3 | | 5 | | | | | |
| 290 | | | | | | | | | | | | | | | | | | | | | | |
| Example | 4 | 70 | 1 | 30 | 5 | | | | | | | | | | | 3 | 5 | | | | | |
| 291 | | | | | | | | | | | | | | | | | | | | | | |
| Example | 4 | 70 | 1 | 30 | 5 | | | | | | | | 3 | | | | | 5 | | | | |
| 292 | | | | | | | | | | | | | | | | | | | | | | |
| Example | 4 | 70 | 1 | 30 | 5 | | | | | | | | 3 | | | | | | 5 | | | |
| 293 | | | | | | | | | | | | | | | | | | | | | | |
| Example | 4 | 70 | 1 | 30 | 5 | | | | | | | | 3 | | | | | | | 5 | | |
| 294 | | | | | | | | | | | | | | | | | | | | | | |
| Example | 4 | 70 | 1 | 30 | 5 | | | | | | | | 3 | | | | | | | | 5 | |
| 295 | | | | | | | | | | | | | | | | | | | | | | |
| Example | 4 | 70 | 1 | 30 | 5 | | | | | | | | 3 | | | | | | | | | 5 |
| 296 | | | | | | | | | | | | | | | | | | | | | | |
| Example | 4 | 70 | 1 | 30 | 5 | | | | | | | | 3 | | | | 0.1 | | | | | |
| 297 | | | | | | | | | | | | | | | | | | | | | | |
| Example | 4 | 70 | 1 | 30 | 5 | | | | | | | | 3 | | | | 1 | | | | | |
| 298 | | | | | | | | | | | | | | | | | | | | | | |
| Example | 4 | 70 | 1 | 30 | 5 | | | | | | | | 3 | | | | 3 | | | | | |
| 299 | | | | | | | | | | | | | | | | | | | | | | |
| Example | 4 | 70 | 1 | 30 | 5 | | | | | | | | 3 | | | | 7 | | | | | |
| 300 | | | | | | | | | | | | | | | | | | | | | | |
| Example | 4 | 70 | 1 | 30 | 5 | | | | | | | | 3 | | | | 10 | | | | | |
| 301 | | | | | | | | | | | | | | | | | | | | | | |
| Example | 4 | 70 | 1 | 30 | 5 | | | | | | | | 0.1 | | | | 5 | | | | | |
| 302 | | | | | | | | | | | | | | | | | | | | | | |
| Example | 4 | 70 | 1 | 30 | 5 | | | | | | | | 1 | | | | 5 | | | | | |
| 303 | | | | | | | | | | | | | | | | | | | | | | |
| Example | 4 | 70 | 1 | 30 | 5 | | | | | | | | 5 | | | | 5 | | | | | |
| 304 | | | | | | | | | | | | | | | | | | | | | | |
| Example | 4 | 70 | 1 | 30 | 5 | | | | | | | | 7 | | | | 5 | | | | | |
| 305 | | | | | | | | | | | | | | | | | | | | | | |
| Example | 4 | 70 | 1 | 30 | 5 | | | | | | | | 10 | | | | 5 | | | | | |
| 306 | | | | | | | | | | | | | | | | | | | | | | |
| Example | 4 | 70 | 1 | 30 | 10 | | | | | | | | 3 | | | | 5 | | | | | |
| 307 | | | | | | | | | | | | | | | | | | | | | | |
| Example | 4 | 70 | 1 | 30 | 15 | | | | | | | | 3 | | | | 5 | | | | | |
| 308 | | | | | | | | | | | | | | | | | | | | | | |
| Example | 4 | 70 | 1 | 30 | 30 | | | | | | | | 3 | | | | 5 | | | | | |
| 309 | | | | | | | | | | | | | | | | | | | | | | |

TABLE 14

| | High refractive | | Highly flexible | | | | | | | | | | Photo- | Amine |
|---|---|---|---|---|---|---|---|---|---|---|---|---|---|---|
| | index monomer 1 | | monomer 1 | | Photoinitiator | | | | | | | | sensitizer | synergist |
| Category | Type | Content | Type | Content | 1 | 2 | 3 | 4 | 5 | 6 | 7 | 8 | 1 | 2 |
| Comparative | 1 | 100 | | | 1 | | | | | | | | | |
| Example 1 | | | | | | | | | | | | | | |
| Comparative | 1 | 100 | | | 0.4 | | | | | | | | | |
| Example 2 | | | | | | | | | | | | | | |
| Comparative | 1 | 100 | | | 31 | | | | | | | | | |
| Example 3 | | | | | | | | | | | | | | |
| Reference | 1 | 91 | 1 | 9 | 8 | | | | | | | | | |
| Example 1 | | | | | | | | | | | | | | |
| Reference | 2 | 91 | 2 | 9 | 8 | | | | | | | | | |
| Example 2 | | | | | | | | | | | | | | |
| Reference | 3 | 91 | 3 | 9 | 8 | | | | | | | | | |
| Example 3 | | | | | | | | | | | | | | |
| Reference | 4 | 91 | 4 | 9 | 8 | | | | | | | | | |
| Example 4 | | | | | | | | | | | | | | |
| Reference | 5 | 91 | 5 | 9 | 8 | | | | | | | | | |
| Example 5 | | | | | | | | | | | | | | |
| Reference | 6 | 91 | 6 | 9 | 8 | | | | | | | | | |
| Example 6 | | | | | | | | | | | | | | |
| Reference | 7 | 91 | 7 | 9 | 8 | | | | | | | | | |
| Example 7 | | | | | | | | | | | | | | |
| Reference | 8 | 91 | 8 | 9 | 8 | | | | | | | | | |
| Example 8 | | | | | | | | | | | | | | |
| Reference | 9 | 91 | 9 | 9 | 8 | | | | | | | | | |
| Example 9 | | | | | | | | | | | | | | |
| Reference | 10 | 91 | 10 | 9 | 8 | | | | | | | | | |
| Example 10 | | | | | | | | | | | | | | |
| Reference | 11 | 91 | 11 | 9 | 8 | | | | | | | | | |
| Example 11 | | | | | | | | | | | | | | |
| Reference | 12 | 91 | 1 | 9 | 8 | | | | | | | | | |
| Example 12 | | | | | | | | | | | | | | |
| Reference | 13 | 91 | 2 | 9 | 8 | | | | | | | | | |
| Example 13 | | | | | | | | | | | | | | |
| Reference | 14 | 91 | 3 | 9 | 8 | | | | | | | | | |
| Example 14 | | | | | | | | | | | | | | |
| Reference | 15 | 91 | 4 | 9 | 8 | | | | | | | | | |
| Example 15 | | | | | | | | | | | | | | |
| Reference | 16 | 91 | 5 | 9 | 8 | | | | | | | | | |
| Example 16 | | | | | | | | | | | | | | |
| Reference | 17 | 91 | 6 | 9 | 8 | | | | | | | | | |
| Example 17 | | | | | | | | | | | | | | |
| Reference | 18 | 91 | 7 | 9 | 8 | | | | | | | | | |
| Example 18 | | | | | | | | | | | | | | |
| Reference | 19 | 91 | 8 | 9 | 8 | | | | | | | | | |
| Example 19 | | | | | | | | | | | | | | |
| Reference | 17 | 60 | 6 | 40 | 8 | | | | | | | | 11 | |
| Example 20 | | | | | | | | | | | | | | |
| Reference | 18 | 60 | 7 | 40 | 8 | | | | | | | | | 11 |
| Example 21 | | | | | | | | | | | | | | |
| Reference | 19 | 60 | 8 | 40 | 8 | | | | | | | | 11 | 11 |
| Example 22 | | | | | | | | | | | | | | |
| Reference | 4 | 91 | 1 | 9 | 5 | | | | | | | | 3 | 5 |
| Example 23 | | | | | | | | | | | | | | |
| Reference | 4 | 70 | 1 | 30 | 5 | | | | | | | | 3 | |
| Example 24 | | | | | | | | | | | | | | |
| Reference | 4 | 70 | 1 | 30 | 5 | | | | | | | | | 5 |
| Example 25 | | | | | | | | | | | | | | |
| Reference | 4 | 70 | 1 | 30 | 5 | | | | | | | | | |
| Example 26 | | | | | | | | | | | | | | |
| Reference | 1 | 90 | 12 | 10 | 8 | | | | | | | | 3 | 5 |
| Example 27 | | | | | | | | | | | | | | |
| Reference | 1 | 80 | 12 | 20 | | 8 | | | | | | | 3 | 5 |
| Example 28 | | | | | | | | | | | | | | |
| Reference | 1 | 70 | 12 | 30 | | | 8 | | | | | | 3 | 5 |
| Example 29 | | | | | | | | | | | | | | |
| Reference | 1 | 60 | 12 | 40 | | | | 8 | | | | | 3 | 5 |
| Example 30 | | | | | | | | | | | | | | |
| Reference | 1 | 50 | 12 | 50 | | | | | 8 | | | | 3 | 5 |
| Example 31 | | | | | | | | | | | | | | |
| Reference | 1 | 40 | 12 | 60 | | | | | | 8 | | | 3 | 5 |
| Example 32 | | | | | | | | | | | | | | |
| Reference | 1 | 30 | 12 | 70 | | | | | | | 8 | | 3 | 5 |
| Example 33 | | | | | | | | | | | | | | |
| Reference | 1 | 20 | 12 | 80 | | | | | | | | 8 | 3 | 5 |
| Example 34 | | | | | | | | | | | | | | |
| Reference | 1 | 10 | 12 | 90 | 8 | | | | | | | | 3 | 5 |
| Example 35 | | | | | | | | | | | | | | |

### Experimental Example

The physical properties such as refractive index, haze and viscosity of each of the optical films prepared in the Examples, Comparative Examples and Reference Examples were measured by the following methods, and the results are shown in Tables 15 to 22 below.

* Method of Measuring Physical Properties of Optical Films

1) Sensitivity

The absorbance was measured before and after exposure using an FT-IR spectrophotometer, and the measurement results were compared. The conversion rate was obtained by integrating the C═O peak of 1650-1750 cm⁻¹ and the C═C peak of 780-880 cm¹, and the sensitivity means the amount of exposure that saturates when the conversion rate is 80% or more.

Evaluation Standard

O: when the sensitivity value is 3 J or less

X: when the sensitivity value is greater than 3 J

2) Refractive Index

The refractive index (average 555-575 nm: wavelength of 565 nm) of the bare glass on which the 2 μm coating film was formed was measured using an ellipsometer.

Evaluation Standard

⊚: when the refractive index measurement value of the coating film is 1.61 or more

O: when the refractive index measurement value of the coating film is 1.58 or more and less than 1.61

X: when the refractive index measurement value of the coating film is less than 1.58

3) Transmittance

The average transmittance of the formed coating film was measured at 380-780 nm using a UV-VIS spectrophotometer (Cary4000, Agilent).

Evaluation Standard

O: when the average transmittance value is 90% or more

X: when the average transmittance value is less than 90%

4) Haze

The haze was measured using a haze meter COH 400 produced by NIPPON DENSHOKU.

Evaluation Standard

⊚: when the haze measurement value is 1.0% or less

O: when the haze measurement value is greater than 1.0% and 3.0% or less

X: when the haze measurement value is greater than 3.0%

5) Viscosity (Absolute Viscosity)

The viscosity of each of the photopolymerizable compositions and olefinic monomers of the Reference Examples and Examples was measured using a viscometer (trade name: Brook Field viscometer) at a temperature of 25° C.

Evaluation Standard

O: when the absolute viscosity value is 5 to 40 cP

X: when the absolute viscosity value is out of the above range

6) Inkjet Processability

It was confirmed whether the surface was formed by changing the nozzle temperature of the inkjet equipment.

Evaluation Standard

Surface formation at nozzle temperature of 25 to 35° C.=⊚

Surface formation at nozzle temperature of 35 to 50° C.=O

No surface formation at nozzle temperature of 25 to 50° C.=X

7) Flexibility

The flexibility was measure using Instron's UTM. That is, a specimen (size: 28 mm×4 mm) was prepared with the above-mentioned 20 μm thickness, and a tensile strain was measured using Instron's UTM. Then, elongation was evaluated from a tensile stress strain curve obtained through the tensile strain.

Evaluation Standard

⊚: when the tensile strain is 10% or more (which means the case where the elongation measured by the tensile stress strain curve is 10% or more)

°: when the tensile strain is 5% or more and less than 10% (which means the case where the elongation measured by the tensile stress strain curve is 5% or more and less than 10%)

[symbol] : when the tensile strain is 1% or more and less than 5% (which means the case where the elongation measured by the tensile stress strain curve is 1% or more and less than 5%)

X: when the tensile strain is less than 1% (which means the case where the elongation measured by the tensile stress strain curve is less than 1%)

TABLE 15

| | | Refractive | | | Absolute | Inkjet | |
|---|---|---|---|---|---|---|---|
| Category | Sensitivity | index | Transmittance | Haze | viscosity | Processability | Flexibility |
| Example 1 | ◯ | ⊚ | ◯ | ◯ | ◯ | ⊚ | ⊚ |
| Example 2 | ◯ | ⊚ | ◯ | ◯ | ◯ | ⊚ | ⊚ |
| Example 3 | ◯ | ⊚ | ◯ | ◯ | ◯ | ⊚ | ⊚ |
| Example 4 | ◯ | ◯ | ◯ | ◯ | ◯ | ⊚ | ⊚ |
| Example 5 | ◯ | ◯ | ◯ | ◯ | ◯ | ⊚ | ◯ |
| Example 6 | ◯ | ◯ | ◯ | ◯ | ◯ | ⊚ | ◯ |
| Example 7 | ◯ | ◯ | ◯ | ◯ | ◯ | ⊚ | ◯ |
| Example 8 | ◯ | ◯ | ◯ | ◯ | ◯ | ⊚ | ◯ |
| Example 9 | ◯ | ◯ | ◯ | ◯ | ◯ | ⊚ | ◯ |
| Example 10 | ◯ | ⊚ | ◯ | ◯ | ◯ | ⊚ | ⊚ |
| Example 11 | ◯ | ⊚ | ◯ | ◯ | ◯ | ⊚ | ⊚ |
| Example 12 | ◯ | ⊚ | ◯ | ◯ | ◯ | ⊚ | ⊚ |
| Example 13 | ◯ | ◯ | ◯ | ◯ | ◯ | ⊚ | ⊚ |
| Example 14 | ◯ | ◯ | ◯ | ◯ | ◯ | ⊚ | ◯ |
| Example 15 | ◯ | ◯ | ◯ | ◯ | ◯ | ⊚ | ◯ |
| Example 16 | ◯ | ◯ | ◯ | ◯ | ◯ | ⊚ | ◯ |
| Example 17 | ◯ | ◯ | ◯ | ◯ | ◯ | ⊚ | ◯ |
| Example 18 | ◯ | ◯ | ◯ | ◯ | ◯ | ⊚ | ◯ |
| Example 19 | ◯ | ⊚ | ◯ | ◯ | ◯ | ⊚ | ⊚ |
| Example 20 | ◯ | ⊚ | ◯ | ◯ | ◯ | ⊚ | ⊚ |
| Example 21 | ◯ | ⊚ | ◯ | ◯ | ◯ | ⊚ | ⊚ |
| Example 22 | ◯ | ◯ | ◯ | ◯ | ◯ | ⊚ | ⊚ |
| Example 23 | ◯ | ◯ | ◯ | ◯ | ◯ | ⊚ | ◯ |
| Example 24 | ◯ | ◯ | ◯ | ◯ | ◯ | ⊚ | ◯ |
| Example 25 | ◯ | ◯ | ◯ | ◯ | ◯ | ⊚ | ◯ |
| Example 26 | ◯ | ◯ | ◯ | ◯ | ◯ | ⊚ | ◯ |
| Example 27 | ◯ | ◯ | ◯ | ◯ | ◯ | ⊚ | ◯ |
| Example 28 | ◯ | ⊚ | ◯ | ◯ | ◯ | ⊚ | ⊚ |
| Example 29 | ◯ | ⊚ | ◯ | ◯ | ◯ | ⊚ | ⊚ |
| Example 30 | ◯ | ⊚ | ◯ | ◯ | ◯ | ⊚ | ⊚ |
| Example 31 | ◯ | ◯ | ◯ | ◯ | ◯ | ⊚ | ⊚ |
| Example 32 | ◯ | ◯ | ◯ | ◯ | ◯ | ⊚ | ◯ |
| Example 33 | ◯ | ◯ | ◯ | ◯ | ◯ | ⊚ | ◯ |
| Example 34 | ◯ | ◯ | ◯ | ◯ | ◯ | ⊚ | ◯ |
| Example 35 | ◯ | ◯ | ◯ | ◯ | ◯ | ⊚ | ◯ |
| Example 36 | ◯ | ◯ | ◯ | ◯ | ◯ | ◯ | ◯ |
| Example 37 | ◯ | ⊚ | ◯ | ◯ | ◯ | ◯ | ⊚ |
| Example 38 | ◯ | ⊚ | ◯ | ◯ | ◯ | ◯ | ⊚ |
| Example 39 | ◯ | ⊚ | ◯ | ◯ | ◯ | ◯ | ⊚ |
| Example 40 | ◯ | ◯ | ◯ | ◯ | ◯ | ⊚ | ⊚ |
| Example 41 | ◯ | ◯ | ◯ | ◯ | ◯ | ⊚ | ◯ |
| Example 42 | ◯ | ◯ | ◯ | ◯ | ◯ | ⊚ | ◯ |
| Example 43 | ◯ | ◯ | ◯ | ◯ | ◯ | ⊚ | ◯ |
| Example 44 | ◯ | ◯ | ◯ | ◯ | ◯ | ⊚ | ◯ |
| Example 45 | ◯ | ◯ | ◯ | ◯ | ◯ | ⊚ | ◯ |
| Example 46 | ◯ | ⊚ | ◯ | ◯ | ◯ | ◯ | ⊚ |
| Example 47 | ◯ | ⊚ | ◯ | ◯ | ◯ | ◯ | ⊚ |
| Example 48 | ◯ | ⊚ | ◯ | ◯ | ◯ | ◯ | ⊚ |
| Example 49 | ◯ | ◯ | ◯ | ◯ | ◯ | ◯ | ⊚ |
| Example 50 | ◯ | ◯ | ◯ | ◯ | ◯ | ◯ | ◯ |

TABLE 16

| | | Refractive | | | Absolute | Inkjet | |
|---|---|---|---|---|---|---|---|
| Category | Sensitivity | index | Transmittance | Haze | viscosity | Processability | Flexibility |
| Example 51 | ◯ | ◯ | ◯ | ◯ | ◯ | ◯ | ◯ |
| Example 52 | ◯ | ◯ | ◯ | ◯ | ◯ | ◯ | ◯ |
| Example 53 | ◯ | ◯ | ◯ | ◯ | ◯ | ◯ | ◯ |
| Example 54 | ◯ | ◯ | ◯ | ◯ | ◯ | ◯ | ◯ |
| Example 55 | ◯ | ⊚ | ◯ | ◯ | ◯ | ◯ | ⊚ |
| Example 56 | ◯ | ⊚ | ◯ | ◯ | ◯ | ◯ | ⊚ |
| Example 57 | ◯ | ⊚ | ◯ | ◯ | ◯ | ◯ | ⊚ |
| Example 58 | ◯ | ◯ | ◯ | ◯ | ◯ | ◯ | ⊚ |
| Example 59 | ◯ | ◯ | ◯ | ◯ | ◯ | ◯ | ◯ |
| Example 60 | ◯ | ◯ | ◯ | ◯ | ◯ | ◯ | ◯ |
| Example 61 | ◯ | ◯ | ◯ | ◯ | ◯ | ◯ | ◯ |
| Example 62 | ◯ | ◯ | ◯ | ◯ | ◯ | ◯ | ◯ |
| Example 63 | ◯ | ◯ | ◯ | ◯ | ◯ | ◯ | ◯ |
| Example 64 | ◯ | ⊚ | ◯ | ◯ | ◯ | ◯ | ⊚ |
| Example 65 | ◯ | ⊚ | ◯ | ◯ | ◯ | ◯ | ⊚ |
| Example 66 | ◯ | ⊚ | ◯ | ◯ | ◯ | ◯ | ⊚ |
| Example 67 | ◯ | ◯ | ◯ | ◯ | ◯ | ◯ | ⊚ |
| Example 68 | ◯ | ◯ | ◯ | ◯ | ◯ | ◯ | ◯ |
| Example 69 | ◯ | ◯ | ◯ | ◯ | ◯ | ◯ | ◯ |
| Example 70 | ◯ | ◯ | ◯ | ◯ | ◯ | ◯ | ◯ |
| Example 71 | ◯ | ◯ | ◯ | ◯ | ◯ | ◯ | ◯ |
| Example 72 | ◯ | ◯ | ◯ | ◯ | ◯ | ◯ | ◯ |
| Example 73 | ◯ | ⊚ | ◯ | ◯ | ◯ | ◯ | ⊚ |
| Example 74 | ◯ | ⊚ | ◯ | ◯ | ◯ | ◯ | ⊚ |
| Example 75 | ◯ | ⊚ | ◯ | ◯ | ◯ | ◯ | ⊚ |
| Example 76 | ◯ | ◯ | ◯ | ◯ | ◯ | ◯ | ⊚ |
| Example 77 | ◯ | ◯ | ◯ | ◯ | ◯ | ◯ | ◯ |
| Example 78 | ◯ | ◯ | ◯ | ◯ | ◯ | ◯ | ◯ |
| Example 79 | ◯ | ◯ | ◯ | ◯ | ◯ | ◯ | ◯ |
| Example 80 | ◯ | ◯ | ◯ | ◯ | ◯ | ◯ | ◯ |
| Example 81 | ◯ | ◯ | ◯ | ◯ | ◯ | ◯ | ◯ |
| Example 82 | ◯ | ⊚ | ◯ | ◯ | ◯ | ◯ | ⊚ |
| Example 83 | ◯ | ⊚ | ◯ | ◯ | ◯ | ◯ | ⊚ |
| Example 84 | ◯ | ⊚ | ◯ | ◯ | ◯ | ◯ | ⊚ |
| Example 85 | ◯ | ◯ | ◯ | ◯ | ◯ | ◯ | ⊚ |
| Example 86 | ◯ | ◯ | ◯ | ◯ | ◯ | ◯ | ◯ |
| Example 87 | ◯ | ◯ | ◯ | ◯ | ◯ | ◯ | ◯ |
| Example 88 | ◯ | ◯ | ◯ | ◯ | ◯ | ◯ | ◯ |
| Example 89 | ◯ | ◯ | ◯ | ◯ | ◯ | ◯ | ◯ |
| Example 90 | ◯ | ◯ | ◯ | ◯ | ◯ | ◯ | ◯ |
| Example 91 | ◯ | ⊚ | ◯ | ◯ | ◯ | ◯ | ⊚ |
| Example 92 | ◯ | ⊚ | ◯ | ◯ | ◯ | ◯ | ⊚ |
| Example 93 | ◯ | ⊚ | ◯ | ◯ | ◯ | ◯ | ⊚ |
| Example 94 | ◯ | ◯ | ◯ | ◯ | ◯ | ◯ | ⊚ |
| Example 95 | ◯ | ◯ | ◯ | ◯ | ◯ | ◯ | ◯ |
| Example 96 | ◯ | ◯ | ◯ | ◯ | ◯ | ◯ | ◯ |
| Example 97 | ◯ | ◯ | ◯ | ◯ | ◯ | ◯ | ◯ |
| Example 98 | ◯ | ◯ | ◯ | ◯ | ◯ | ◯ | ◯ |
| Example 99 | ◯ | ◯ | ◯ | ◯ | ◯ | ◯ | ◯ |
| Example 100 | ◯ | ⊚ | ◯ | ◯ | ◯ | ◯ | ⊚ |

TABLE 17

| | | Refractive | | | Absolute | Inkjet | |
|---|---|---|---|---|---|---|---|
| Category | Sensitivity | index | Transmittance | Haze | viscosity | Processability | Flexibility |
| Example 101 | ◯ | ⊚ | ◯ | ◯ | ◯ | ◯ | ⊚ |
| Example 102 | ◯ | ⊚ | ◯ | ◯ | ◯ | ◯ | ⊚ |
| Example 103 | ◯ | ◯ | ◯ | ◯ | ◯ | ◯ | ⊚ |
| Example 104 | ◯ | ◯ | ◯ | ◯ | ◯ | ◯ | ◯ |
| Example 105 | ◯ | ◯ | ◯ | ◯ | ◯ | ◯ | ◯ |
| Example 106 | ◯ | ◯ | ◯ | ◯ | ◯ | ◯ | ◯ |
| Example 107 | ◯ | ◯ | ◯ | ◯ | ◯ | ◯ | ◯ |
| Example 108 | ◯ | ◯ | ◯ | ◯ | ◯ | ◯ | ◯ |
| Example 109 | ◯ | ⊚ | ◯ | ◯ | ◯ | ◯ | ⊚ |
| Example 110 | ◯ | ⊚ | ◯ | ◯ | ◯ | ◯ | ⊚ |
| Example 111 | ◯ | ⊚ | ◯ | ◯ | ◯ | ◯ | ⊚ |
| Example 112 | ◯ | ◯ | ◯ | ◯ | ◯ | ◯ | ⊚ |
| Example 113 | ◯ | ◯ | ◯ | ◯ | ◯ | ◯ | ◯ |
| Example 114 | ◯ | ◯ | ◯ | ◯ | ◯ | ◯ | ◯ |
| Example 115 | ◯ | ◯ | ◯ | ◯ | ◯ | ◯ | ◯ |
| Example 116 | ◯ | ◯ | ◯ | ◯ | ◯ | ◯ | ◯ |
| Example 117 | ◯ | ◯ | ◯ | ◯ | ◯ | ◯ | ◯ |
| Example 118 | ◯ | ⊚ | ◯ | ◯ | ◯ | ◯ | ⊚ |
| Example 119 | ◯ | ⊚ | ◯ | ◯ | ◯ | ◯ | ⊚ |
| Example 120 | ◯ | ⊚ | ◯ | ◯ | ◯ | ◯ | ⊚ |
| Example 121 | ◯ | ◯ | ◯ | ◯ | ◯ | ◯ | ⊚ |
| Example 122 | ◯ | ◯ | ◯ | ◯ | ◯ | ◯ | ◯ |
| Example 123 | ◯ | ◯ | ◯ | ◯ | ◯ | ◯ | ◯ |
| Example 124 | ◯ | ◯ | ◯ | ◯ | ◯ | ◯ | ◯ |
| Example 125 | ◯ | ◯ | ◯ | ◯ | ◯ | ◯ | ◯ |
| Example 126 | ◯ | ◯ | ◯ | ◯ | ◯ | ◯ | ◯ |
| Example 127 | ◯ | ⊚ | ◯ | ◯ | ◯ | ◯ | ⊚ |
| Example 128 | ◯ | ⊚ | ◯ | ◯ | ◯ | ◯ | ⊚ |
| Example 129 | ◯ | ⊚ | ◯ | ◯ | ◯ | ◯ | ⊚ |
| Example 130 | ◯ | ◯ | ◯ | ◯ | ◯ | ◯ | ⊚ |
| Example 131 | ◯ | ◯ | ◯ | ◯ | ◯ | ◯ | ◯ |
| Example 132 | ◯ | ◯ | ◯ | ◯ | ◯ | ◯ | ◯ |
| Example 133 | ◯ | ◯ | ◯ | ◯ | ◯ | ◯ | ◯ |
| Example 134 | ◯ | ◯ | ◯ | ◯ | ◯ | ◯ | ◯ |
| Example 135 | ◯ | ◯ | ◯ | ◯ | ◯ | ◯ | ◯ |
| Example 136 | ◯ | ⊚ | ◯ | ◯ | ◯ | ◯ | ⊚ |
| Example 137 | ◯ | ⊚ | ◯ | ◯ | ◯ | ◯ | ⊚ |
| Example 138 | ◯ | ⊚ | ◯ | ◯ | ◯ | ◯ | ⊚ |
| Example 139 | ◯ | ◯ | ◯ | ◯ | ◯ | ◯ | ⊚ |
| Example 140 | ◯ | ◯ | ◯ | ◯ | ◯ | ◯ | ◯ |
| Example 141 | ◯ | ◯ | ◯ | ◯ | ◯ | ◯ | ◯ |
| Example 142 | ◯ | ◯ | ◯ | ◯ | ◯ | ◯ | ◯ |
| Example 143 | ◯ | ◯ | ◯ | ◯ | ◯ | ◯ | ◯ |
| Example 144 | ◯ | ◯ | ◯ | ◯ | ◯ | ◯ | ◯ |
| Example 145 | ◯ | ⊚ | ◯ | ◯ | ◯ | ◯ | ⊚ |
| Example 146 | ◯ | ⊚ | ◯ | ◯ | ◯ | ◯ | ⊚ |
| Example 147 | ◯ | ⊚ | ◯ | ◯ | ◯ | ◯ | ⊚ |
| Example 148 | ◯ | ◯ | ◯ | ◯ | ◯ | ◯ | ⊚ |
| Example 149 | ◯ | ◯ | ◯ | ◯ | ◯ | ◯ | ◯ |
| Example 150 | ◯ | ◯ | ◯ | ◯ | ◯ | ◯ | ◯ |

TABLE 18

| | | Refractive | | | Absolute | Inkjet | |
|---|---|---|---|---|---|---|---|
| Category | Sensitivity | index | Transmittance | Haze | viscosity | Processability | Flexibility |
| Example 151 | ◯ | ◯ | ◯ | ◯ | ◯ | ◯ | ◯ |
| Example 152 | ◯ | ◯ | ◯ | ◯ | ◯ | ◯ | ◯ |
| Example 153 | ◯ | ◯ | ◯ | ◯ | ◯ | ◯ | ◯ |
| Example 154 | ◯ | ⊚ | ◯ | ◯ | ◯ | ◯ | ⊚ |
| Example 155 | ◯ | ⊚ | ◯ | ◯ | ◯ | ◯ | ⊚ |
| Example 156 | ◯ | ⊚ | ◯ | ◯ | ◯ | ◯ | ⊚ |
| Example 157 | ◯ | ⊚ | ◯ | ◯ | ◯ | ◯ | ⊚ |
| Example 158 | ◯ | ◯ | ◯ | ◯ | ◯ | ◯ | ◯ |
| Example 159 | ◯ | ◯ | ◯ | ◯ | ◯ | ◯ | ◯ |
| Example 160 | ◯ | ◯ | ◯ | ◯ | ◯ | ◯ | ◯ |
| Example 161 | ◯ | ◯ | ◯ | ◯ | ◯ | ◯ | ◯ |
| Example 162 | ◯ | ◯ | ◯ | ◯ | ◯ | ◯ | ◯ |
| Example 163 | ◯ | ⊚ | ◯ | ◯ | ◯ | ◯ | ⊚ |
| Example 164 | ◯ | ⊚ | ◯ | ◯ | ◯ | ◯ | ⊚ |
| Example 165 | ◯ | ⊚ | ◯ | ◯ | ◯ | ◯ | ⊚ |
| Example 166 | ◯ | ◯ | ◯ | ◯ | ◯ | ◯ | ⊚ |
| Example 167 | ◯ | ◯ | ◯ | ◯ | ◯ | ◯ | ◯ |
| Example 168 | ◯ | ◯ | ◯ | ◯ | ◯ | ◯ | ◯ |
| Example 169 | ◯ | ◯ | ◯ | ◯ | ◯ | ◯ | ◯ |
| Example 170 | ◯ | ◯ | ◯ | ◯ | ◯ | ◯ | ◯ |
| Example 171 | ◯ | ◯ | ◯ | ◯ | ◯ | ◯ | ◯ |
| Example 172 | ◯ | ◯ | ◯ | ◯ | ◯ | ⊚ | ⊚ |
| Example 173 | ◯ | ◯ | ◯ | ◯ | ◯ | ⊚ | ⊚ |
| Example 174 | ◯ | ◯ | ◯ | ◯ | ◯ | ⊚ | ⊚ |
| Example 175 | ◯ | ◯ | ◯ | ⊚ | ◯ | ⊚ | ⊚ |
| Example 176 | ◯ | ◯ | ◯ | ⊚ | ◯ | ⊚ | ⊚ |
| Example 177 | ◯ | ◯ | ◯ | ⊚ | ◯ | ⊚ | ⊚ |
| Example 178 | ◯ | ◯ | ◯ | ◯ | ◯ | ⊚ | ⊚ |
| Example 179 | ◯ | ◯ | ◯ | ◯ | ◯ | ⊚ | ⊚ |
| Example 180 | ◯ | ◯ | ◯ | ◯ | ◯ | ⊚ | ⊚ |
| Example 181 | ◯ | ◯ | ◯ | ⊚ | ◯ | ⊚ | ⊚ |
| Example 182 | ◯ | ◯ | ◯ | ⊚ | ◯ | ⊚ | ⊚ |
| Example 183 | ◯ | ◯ | ◯ | ⊚ | ◯ | ⊚ | ⊚ |
| Example 184 | ◯ | ◯ | ◯ | ⊚ | ◯ | ⊚ | ⊚ |
| Example 185 | ◯ | ◯ | ◯ | ⊚ | ◯ | ⊚ | ⊚ |
| Example 186 | ◯ | ◯ | ◯ | ⊚ | ◯ | ⊚ | ⊚ |
| Example 187 | ◯ | ◯ | ◯ | ⊚ | ◯ | ⊚ | ⊚ |
| Example 188 | ◯ | ◯ | ◯ | ⊚ | ◯ | ⊚ | ⊚ |
| Example 189 | ◯ | ◯ | ◯ | ⊚ | ◯ | ⊚ | ⊚ |
| Example 190 | ◯ | ◯ | ◯ | ◯ | ◯ | ⊚ | ⊚ |
| Example 191 | ◯ | ◯ | ◯ | ⊚ | ◯ | ⊚ | ⊚ |
| Example 192 | ◯ | ◯ | ◯ | ⊚ | ◯ | ⊚ | ⊚ |
| Example 193 | ◯ | ◯ | ◯ | ⊚ | ◯ | ⊚ | ⊚ |
| Example 194 | ◯ | ◯ | ◯ | ◯ | ◯ | ⊚ | ⊚ |
| Example 194-1 | ◯ | ◯ | ◯ | ⊚ | ◯ | ⊚ | ⊚ |
| Example 194-2 | ◯ | ◯ | ◯ | ⊚ | ◯ | ⊚ | ⊚ |
| Example 195 | ◯ | ◯ | ◯ | ⊚ | ◯ | ⊚ | ⊚ |
| Example 196 | ◯ | ◯ | ◯ | ◯ | ◯ | ⊚ | ⊚ |
| Example 197 | ◯ | ◯ | ◯ | ◯ | ◯ | ⊚ | ⊚ |
| Example 198 | ◯ | ◯ | ◯ | ◯ | ◯ | ⊚ | ⊚ |
| Example 199 | ◯ | ◯ | ◯ | ◯ | ◯ | ⊚ | ⊚ |
| Example 200 | ◯ | ◯ | ◯ | ◯ | ◯ | ⊚ | ⊚ |
| Example 201 | ◯ | ◯ | ◯ | ◯ | ◯ | ⊚ | ⊚ |
| Example 202 | ◯ | ◯ | ◯ | ◯ | ◯ | ⊚ | ⊚ |

TABLE 19

| | | Refractive | | | Absolute | Inkjet | |
|---|---|---|---|---|---|---|---|
| Category | Sensitivity | index | Transmittance | Haze | viscosity | Processability | Flexibility |
| Example 203 | ◯ | ◯ | ◯ | ⊚ | ◯ | ⊚ | ⊚ |
| Example 204 | ◯ | ◯ | ◯ | ⊚ | ◯ | ⊚ | ⊚ |
| Example 205 | ◯ | ◯ | ◯ | ⊚ | ◯ | ⊚ | ⊚ |
| Example 206 | ◯ | ◯ | ◯ | ⊚ | ◯ | ⊚ | ⊚ |
| Example 207 | ◯ | ◯ | ◯ | ⊚ | ◯ | ⊚ | ⊚ |
| Example 208 | ◯ | ◯ | ◯ | ⊚ | ◯ | ⊚ | ⊚ |
| Example 209 | ◯ | ◯ | ◯ | ⊚ | ◯ | ⊚ | ⊚ |
| Example 210 | ◯ | ◯ | ◯ | ⊚ | ◯ | ⊚ | ⊚ |
| Example 211 | ◯ | ◯ | ◯ | ⊚ | ◯ | ⊚ | ⊚ |
| Example 212 | ◯ | ◯ | ◯ | ⊚ | ◯ | ⊚ | ⊚ |
| Example 213 | ◯ | ◯ | ◯ | ⊚ | ◯ | ⊚ | ⊚ |
| Example 214 | ◯ | ◯ | ◯ | ⊚ | ◯ | ⊚ | ⊚ |
| Example 215 | ◯ | ◯ | ◯ | ⊚ | ◯ | ⊚ | ⊚ |
| Example 216 | ◯ | ◯ | ◯ | ⊚ | ◯ | ⊚ | ⊚ |
| Example 217 | ◯ | ◯ | ◯ | ⊚ | ◯ | ⊚ | ⊚ |
| Example 218 | ◯ | ◯ | ◯ | ⊚ | ◯ | ⊚ | ⊚ |
| Example 219 | ◯ | ◯ | ◯ | ⊚ | ◯ | ⊚ | ⊚ |
| Example 220 | ◯ | ◯ | ◯ | ⊚ | ◯ | ⊚ | ⊚ |
| Example 221 | ◯ | ◯ | ◯ | ⊚ | ◯ | ⊚ | ⊚ |
| Example 222 | ◯ | ◯ | ◯ | ⊚ | ◯ | ⊚ | ⊚ |
| Example 223 | ◯ | ◯ | ◯ | ⊚ | ◯ | ⊚ | ⊚ |
| Example 224 | ◯ | ◯ | ◯ | ⊚ | ◯ | ⊚ | ⊚ |
| Example 225 | ◯ | ◯ | ◯ | ⊚ | ◯ | ⊚ | ⊚ |
| Example 226 | ◯ | ⊚ | ◯ | ◯ | ◯ | ◯ | ⊚ |
| Example 227 | ◯ | ⊚ | ◯ | ◯ | ◯ | ◯ | ⊚ |
| Example 228 | ◯ | ⊚ | ◯ | ◯ | ◯ | ◯ | ⊚ |
| Example 229 | ◯ | ⊚ | ◯ | ◯ | ◯ | ◯ | ⊚ |
| Example 230 | ◯ | ⊚ | ◯ | ◯ | ◯ | ◯ | ⊚ |
| Example 231 | ◯ | ⊚ | ◯ | ◯ | ◯ | ◯ | ⊚ |
| Example 232 | ◯ | ⊚ | ◯ | ◯ | ◯ | ◯ | ⊚ |
| Example 233 | ◯ | ⊚ | ◯ | ◯ | ◯ | ◯ | ⊚ |
| Example 234 | ◯ | ⊚ | ◯ | ◯ | ◯ | ◯ | ⊚ |
| Example 235 | ◯ | ⊚ | ◯ | ◯ | ◯ | ◯ | ⊚ |
| Example 236 | ◯ | ⊚ | ◯ | ◯ | ◯ | ◯ | ⊚ |
| Example 237 | ◯ | ⊚ | ◯ | ◯ | ◯ | ◯ | ⊚ |
| Example 238 | ◯ | ⊚ | ◯ | ◯ | ◯ | ◯ | ⊚ |
| Example 239 | ◯ | ⊚ | ◯ | ◯ | ◯ | ◯ | ⊚ |
| Example 240 | ◯ | ⊚ | ◯ | ◯ | ◯ | ◯ | ⊚ |
| Example 241 | ◯ | ◯ | ◯ | ◯ | ◯ | ⊚ | ⊚ |
| Example 242 | ◯ | ◯ | ◯ | ◯ | ◯ | ⊚ | ⊚ |
| Example 243 | ◯ | ◯ | ◯ | ◯ | ◯ | ⊚ | ⊚ |
| Example 244 | ◯ | ◯ | ◯ | ◯ | ◯ | ⊚ | ◯ |

TABLE 20

| | | Refractive | | | Absolute | Inkjet | |
|---|---|---|---|---|---|---|---|
| Category | Sensitivity | index | Transmittance | Haze | viscosity | Processability | Flexibility |
| Example 245 | ◯ | ◯ | ◯ | ⊚ | ◯ | ⊚ | ⊚ |
| Example 246 | ◯ | ◯ | ◯ | ⊚ | ◯ | ⊚ | ⊚ |
| Example 247 | ◯ | ◯ | ◯ | ⊚ | ◯ | ⊚ | ⊚ |
| Example 248 | ◯ | ◯ | ◯ | ⊚ | ◯ | ⊚ | ⊚ |
| Example 249 | ◯ | ◯ | ◯ | ⊚ | ◯ | ⊚ | ⊚ |
| Example 250 | ◯ | ⊚ | ◯ | ⊚ | ◯ | ◯ | ⊚ |
| Example 251 | ◯ | ⊚ | ◯ | ⊚ | ◯ | ◯ | ⊚ |
| Example 252 | ◯ | ⊚ | ◯ | ⊚ | ◯ | ◯ | ⊚ |
| Example 253 | ◯ | ⊚ | ◯ | ⊚ | ◯ | ◯ | ⊚ |
| Example 254 | ◯ | ◯ | ◯ | ⊚ | ◯ | ⊚ | ⊚ |
| Example 255 | ◯ | ◯ | ◯ | ⊚ | ◯ | ⊚ | ⊚ |
| Example 256 | ◯ | ◯ | ◯ | ⊚ | ◯ | ⊚ | ⊚ |
| Example 257 | ◯ | ◯ | ◯ | ⊚ | ◯ | ⊚ | ⊚ |
| Example 258 | ◯ | ⊚ | ◯ | ⊚ | ◯ | ⊚ | ◯ |
| Example 259 | ◯ | ⊚ | ◯ | ⊚ | ◯ | ⊚ | ◯ |
| Example 260 | ◯ | ◯ | ◯ | ⊚ | ◯ | ◯ | ⊚ |
| Example 261 | ◯ | ◯ | ◯ | ⊚ | ◯ | ◯ | ⊚ |
| Example 262 | ◯ | ◯ | ◯ | ⊚ | ◯ | ◯ | ⊚ |
| Example 263 | ◯ | ◯ | ◯ | ⊚ | ◯ | ◯ | ⊚ |
| Example 264 | ◯ | ◯ | ◯ | ⊚ | ◯ | ◯ | ⊚ |
| Example 265 | ◯ | ◯ | ◯ | ⊚ | ◯ | ◯ | ⊚ |
| Example 266 | ◯ | ◯ | ◯ | ⊚ | ◯ | ◯ | ⊚ |
| Example 267 | ◯ | ◯ | ◯ | ⊚ | ◯ | ◯ | ⊚ |
| Example 268 | ◯ | ◯ | ◯ | ⊚ | ◯ | ◯ | ⊚ |
| Example 269 | ◯ | ◯ | ◯ | ⊚ | ◯ | ◯ | ⊚ |
| Example 270 | ◯ | ⊚ | ◯ | ⊚ | ◯ | ◯ | ⊚ |
| Example 271 | ◯ | ⊚ | ◯ | ⊚ | ◯ | ◯ | ⊚ |
| Example 272 | ◯ | ⊚ | ◯ | ⊚ | ◯ | ◯ | ⊚ |
| Example 273 | ◯ | ⊚ | ◯ | ⊚ | ◯ | ◯ | ⊚ |
| Example 274 | ◯ | ⊚ | ◯ | ⊚ | ◯ | ◯ | ⊚ |
| Example 275 | ◯ | ⊚ | ◯ | ⊚ | ◯ | ◯ | ⊚ |
| Example 276 | ◯ | ⊚ | ◯ | ⊚ | ◯ | ◯ | ⊚ |
| Example 277 | ◯ | ◯ | ◯ | ⊚ | ◯ | ⊚ | ⊚ |
| Example 278 | ◯ | ◯ | ◯ | ⊚ | ◯ | ⊚ | ⊚ |
| Example 279 | ◯ | ◯ | ◯ | ⊚ | ◯ | ⊚ | ⊚ |
| Example 280 | ◯ | ◯ | ◯ | ⊚ | ◯ | ⊚ | ⊚ |
| Example 281 | ◯ | ◯ | ◯ | ⊚ | ◯ | ⊚ | ⊚ |

TABLE 21

| | | Refractive | | | Absolute | Inkjet | |
|---|---|---|---|---|---|---|---|
| Category | Sensitivity | index | Transmittance | Haze | viscosity | Processability | Flexibility |
| Example 282 | ◯ | ◯ | ◯ | ⊚ | ◯ | ⊚ | ⊚ |
| Example 283 | ◯ | ◯ | ◯ | ⊚ | ◯ | ⊚ | ⊚ |
| Example 284 | ◯ | ◯ | ◯ | ⊚ | ◯ | ⊚ | ⊚ |
| Example 285 | ◯ | ◯ | ◯ | ⊚ | ◯ | ⊚ | ⊚ |
| Example 286 | ◯ | ◯ | ◯ | ⊚ | ◯ | ⊚ | ⊚ |
| Example 287 | ◯ | ◯ | ◯ | ⊚ | ◯ | ⊚ | ⊚ |
| Example 288 | ◯ | ◯ | ◯ | ⊚ | ◯ | ⊚ | ⊚ |
| Example 289 | ◯ | ◯ | ◯ | ⊚ | ◯ | ⊚ | ⊚ |
| Example 290 | ◯ | ◯ | ◯ | ⊚ | ◯ | ⊚ | ⊚ |
| Example 291 | ◯ | ◯ | ◯ | ⊚ | ◯ | ⊚ | ⊚ |
| Example 292 | ◯ | ◯ | ◯ | ⊚ | ◯ | ⊚ | ⊚ |
| Example 293 | ◯ | ◯ | ◯ | ⊚ | ◯ | ⊚ | ⊚ |
| Example 294 | ◯ | ◯ | ◯ | ⊚ | ◯ | ⊚ | ⊚ |
| Example 295 | ◯ | ◯ | ◯ | ⊚ | ◯ | ⊚ | ⊚ |
| Example 296 | ◯ | ◯ | ◯ | ⊚ | ◯ | ⊚ | ⊚ |
| Example 297 | ◯ | ◯ | ◯ | ◯ | ◯ | ⊚ | ⊚ |
| Example 298 | ◯ | ◯ | ◯ | ◯ | ◯ | ⊚ | ⊚ |
| Example 299 | ◯ | ◯ | ◯ | ◯ | ◯ | ⊚ | ⊚ |
| Example 300 | ◯ | ◯ | ◯ | ⊚ | ◯ | ◯ | ⊚ |
| Example 301 | ◯ | ◯ | ◯ | ⊚ | ◯ | ◯ | ⊚ |
| Example 302 | ◯ | ◯ | ◯ | ◯ | ◯ | ⊚ | ⊚ |
| Example 303 | ◯ | ◯ | ◯ | ◯ | ◯ | ⊚ | ⊚ |
| Example 304 | ◯ | ◯ | ◯ | ⊚ | ◯ | ⊚ | ⊚ |
| Example 305 | ◯ | ◯ | ◯ | ⊚ | ◯ | ◯ | ⊚ |
| Example 306 | ◯ | ◯ | ◯ | ⊚ | ◯ | ◯ | ⊚ |
| Example 307 | ◯ | ◯ | ◯ | ⊚ | ◯ | ⊚ | ⊚ |
| Example 308 | ◯ | ◯ | ◯ | ⊚ | ◯ | ◯ | ⊚ |
| Example 309 | ◯ | ◯ | ◯ | ⊚ | ◯ | ◯ | ⊚ |

TABLE 22

| | | Refractive | | | Absolute | Inkjet | |
|---|---|---|---|---|---|---|---|
| Category | Sensitivity | index | Transmittance | Haze | viscosity | Processability | Flexibility |
| Comparative | ◯ | ◯ | ◯ | ◯ | ◯ | ⊚ | X |
| Example 1 | | | | | | | |
| Comparative | X | | | | | | |
| Example 2 | | | | | | | |
| Comparative | Initiator | | | | | | |
| Example 3 | precipitation | | | | | | |
| Reference | ◯ | ⊚ | ◯ | ◯ | ◯ | ⊚ | Δ |
| Example 1 | | | | | | | |
| Reference | ◯ | ⊚ | ◯ | ◯ | ◯ | ⊚ | Δ |
| Example 2 | | | | | | | |
| Reference | ◯ | ⊚ | ◯ | ◯ | ◯ | ⊚ | Δ |
| Example 3 | | | | | | | |
| Reference | ◯ | ⊚ | ◯ | ◯ | ◯ | ⊚ | Δ |
| Example 4 | | | | | | | |
| Reference | ◯ | ⊚ | ◯ | ◯ | ◯ | ⊚ | Δ |
| Example 5 | | | | | | | |
| Reference | ◯ | ⊚ | ◯ | ◯ | ◯ | ⊚ | Δ |
| Example 6 | | | | | | | |
| Reference | ◯ | ⊚ | ◯ | ◯ | ◯ | ◯ | Δ |
| Example 7 | | | | | | | |
| Reference | ◯ | ⊚ | ◯ | ◯ | ◯ | ◯ | Δ |
| Example 8 | | | | | | | |
| Reference | ◯ | ⊚ | ◯ | ◯ | ◯ | ◯ | Δ |
| Example 9 | | | | | | | |
| Reference | ◯ | ⊚ | ◯ | ◯ | ◯ | ◯ | Δ |
| Example 10 | | | | | | | |
| Reference | ◯ | ⊚ | ◯ | ◯ | ◯ | ◯ | Δ |
| Example 11 | | | | | | | |
| Reference | ◯ | ⊚ | ◯ | ◯ | ◯ | ◯ | Δ |
| Example 12 | | | | | | | |
| Reference | ◯ | ⊚ | ◯ | ◯ | ◯ | ◯ | Δ |
| Example 13 | | | | | | | |
| Reference | ◯ | ⊚ | ◯ | ◯ | ◯ | ◯ | Δ |
| Example 14 | | | | | | | |
| Reference | ◯ | ⊚ | ◯ | ◯ | ◯ | ◯ | Δ |
| Example 15 | | | | | | | |
| Reference | ◯ | ⊚ | ◯ | ◯ | ◯ | ◯ | Δ |
| Example 16 | | | | | | | |
| Reference | ◯ | ⊚ | ◯ | ◯ | ◯ | ◯ | Δ |
| Example 17 | | | | | | | |
| Reference | ◯ | ⊚ | ◯ | ◯ | ◯ | ◯ | Δ |
| Example 18 | | | | | | | |
| Reference | ◯ | ⊚ | ◯ | | ◯ | ◯ | Δ |
| Example 19 | | | | | | | |
| Reference | ◯ | ◯ | X | X | X | X | ◯ |
| Example 20 | | | | | | | |
| Reference | ◯ | ◯ | X | X | X | X | ◯ |
| Example 21 | | | | | | | |
| Reference | ◯ | ◯ | X | X | X | X | ◯ |
| Example 22 | | | | | | | |
| Reference | ◯ | ◯ | ◯ | ◯ | ◯ | X | Δ |
| Example 23 | | | | | | | |
| Reference | ◯ | ◯ | ◯ | X | ◯ | ◯ | ◯ |
| Example 24 | | | | | | | |
| Reference | ◯ | ◯ | ◯ | X | ◯ | ◯ | ◯ |
| Example 25 | | | | | | | |
| Reference | X | ◯ | ◯ | X | ◯ | ◯ | ◯ |
| Example 26 | | | | | | | |
| Reference | ◯ | ◯ | ◯ | ◯ | X | ⊚ | ◯ |
| Example 27 | | | | | | | |
| Reference | ◯ | ◯ | ◯ | ◯ | X | ⊚ | ◯ |
| Example 28 | | | | | | | |
| Reference | ◯ | X | ◯ | ◯ | X | ⊚ | ◯ |
| Example 29 | | | | | | | |
| Reference | ◯ | X | ◯ | ◯ | X | ⊚ | ◯ |
| Example 30 | | | | | | | |
| Reference | ◯ | X | ◯ | ◯ | X | ⊚ | ◯ |
| Example 31 | | | | | | | |
| Reference | ◯ | X | ◯ | ◯ | X | ⊚ | ◯ |
| Example 32 | | | | | | | |
| Reference | ◯ | X | ◯ | ◯ | X | ⊚ | ◯ |
| Example 33 | | | | | | | |
| Reference | ◯ | X | ◯ | ◯ | X | ⊚ | ◯ |
| Example 34 | | | | | | | |
| Reference | | X | ◯ | ◯ | X | ⊚ | ◯ |
| Example 35 | | | | | | | |

Looking at the results of Tables 15 to 22, it was confirmed that Examples 1 to 309 include a high refractive index monomer and a highly flexible monomer capable of preventing cracks in an optimal configuration together with a high refractive index monomer, a photoinitiator and the like, and thus, exhibit a low haze while having good refractive index and viscosity as compared with Comparative Examples and Reference Examples. Particularly, it is considered that as compared with Comparative Examples and Reference Examples, Examples have excellent flexibility, sensitivity, transmittance, and heat resistance as well as inkjet processability, and thus can contribute to improvement in performance when applied as an optical member from a foldable or flexible display device. In particular, it was found that Comparative Example 1 cannot exhibit the flexibility if a highly flexible monomer is not used. In addition, in Comparative Examples 2 and 3, since the content of the photoinitiator was either too small or too large, the sensitivity cannot be measured or the initiator is precipitated, which makes it impossible to measure the physical properties.

1. A photopolymerizable composition comprising:
a) at least one high refractive index monomer having a liquid refractive index of 1.51 or more before curing;
b) at least one flexible monomer; and
c) a photopolymerization initiator.

2. The photopolymerizable composition of claim 1, wherein the high refractive index monomer is an aromatic or alicyclic photocurable compound containing one or more aromatic rings or one or more heteroatoms.

3. The photopolymerizable composition of claim 1, wherein the high refractive index monomer is an aromatic photocurable compound including a structure of the following Chemical Formula 1:
B—Z1—Z2—R [Chemical Formula 1]
wherein, in Chemical Formula 1, B includes an aryl group having 6 to 30 carbon atoms, at least one structure of a 5-7 membered aliphatic heterocyclic structure substituted with one or more sulfur (S) or a 5-7 membered aromatic heterocyclic structure substituted with one or more sulfur (S),
Z1 is a direct bond or an alkyl group having 1 to 10 carbon atoms,
Z2 is a direct bond or an alkyl group having 1 to 10 carbon atoms containing at least one oxygen (O) or sulfur (S), and
R is a photocurable functional group.

4. The photopolymerizable composition of claim 3, wherein the high refractive index monomer includes a structure of Chemical Formula 1 where B is an aryl group having 6 to 30 carbon atoms, Z1 is a direct bond, and Z2 is an alkyl group of 1 to 10 carbon atoms containing at least one oxygen (O).

5. The photopolymerizable composition of claim 4, wherein the high refractive index monomer includes a structure of Chemical Formula 1 where B is an aryl group having 6 to 30 carbon atoms, Z1 is a direct bond, and Z2 includes at least one oxygen (O) and an aromatic ring structure together.

6. The photopolymerizable composition of claim 3, wherein the high refractive index monomer includes a structure of Chemical Formula 1 where B includes a 5-7 membered aromatic heterocyclic structure substituted with at least one sulfur (S), Z1 is a direct bond, and Z2 is an alkyl group of 1 to 10 carbon atoms containing at least one sulfur (S).

7. The photopolymerizable composition of claim 1, wherein the high refractive index monomer is at least one selected from the group consisting of benzyl (meth)acrylate, phenoxyethyl (meth)acrylate, phenoxybenzyl (meth)acrylate, 0-phenylphenoxyethyl (meth)acrylate, biphenyl ethyl (meth)acrylate, and the following Chemical Formulas 2 to 8: 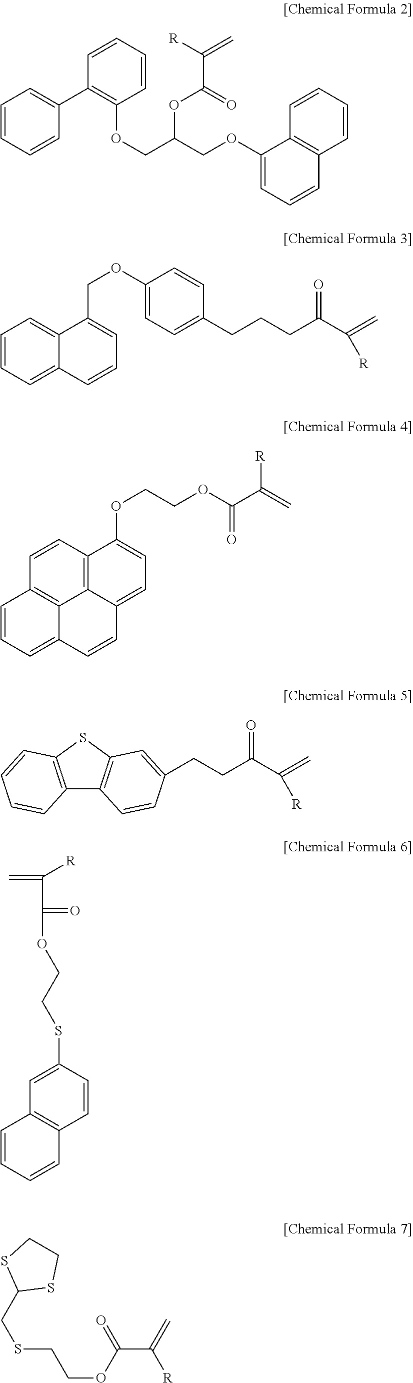 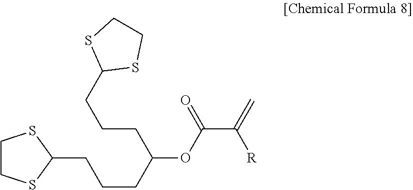
wherein, in Chemical Formulas 2 to 8, each R is independently H or CH₃.

8. The photopolymerizable composition of claim 1, wherein the flexible monomer includes a structure represented by the following Chemical Formula 9:
(A)m-B(A′)n [Chemical Formula 9]
wherein, in Chemical Formula 9,
A and A′ are photocurable functional groups, which may be identical or different,
B is an aliphatic structure having 6 to 50 carbon atoms containing or not containing one or more oxygen atoms, and includes a liner alkyl structure having at least 6 or more carbon atoms, and
m and n are integers of 0 or 1.

9. The photopolymerizable composition of claim 8, wherein the flexible monomer has a structure of Chemical Formula 9 where B contains 4 to 20 oxygen atoms.

10. The photopolymerizable composition of claim 1, wherein the flexible monomer includes at least one selected from the group consisting of isodecyl (meth)acrylate, lauryl (meth)acrylate, stearyl (meth)acrylate, ethoxy ethyl (meth)acrylate, ethoxy ethoxy ethyl (meth)acrylate, triethylene glycol di(meth)acrylate, tetraethylene glycol di(meth)acrylate, dipropylene glycol di(meth)acrylate, tripropylene glycol di(meth)acrylate and the following Chemical Formula 10: 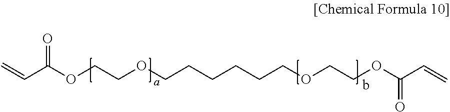
wherein, in Chemical Formula 10, 0≤a+b≤10, and a and b are integers.

11. The photopolymerizable composition of claim 10, wherein a and b in Chemical Formula 10 are integers of 1 to 5, respectively.

12. The photopolymerizable composition of claim 1, wherein the flexible monomer is contained in an amount of 10 to 90 parts by weight based on total 100 parts by weight of the high refractive index monomer and the flexible monomer.

13. The photopolymerizable composition of claim 1, wherein the flexible monomer is contained in an amount of 10 to 40 parts by weight based on total 100 parts by weight of the high refractive index monomer and the flexible monomer.

14. The photopolymerizable composition of claim 1, wherein the photopolymerization initiator is contained in an amount of 0.5 to 30 parts by weight based on total 100 parts by weight of the high refractive index monomer and the flexible monomer.

15. The photopolymerizable composition of claim 1, wherein an absolute viscosity measured at 25° C. of the photopolymerizable composition is 5 cP to 40 cP.

16. The photopolymerizable composition of claim 1, further comprising 0.1 to 10 parts by weight of an amine synergist based on total 100 parts by weight of the high refractive index monomer and the flexible monomer.

17. The photopolymerizable composition of claim 16, wherein the amine synergist includes at least one selected from the group consisting of a compound of the following Chemical Formula 11, ethyl dimethylamino benzoate, butoxyethyl dimethylamino benzoate, bis(diethylamino)benzophenone, bis(2-hydroxyethyl)-toluidine, ethylhexyl-(dimethylamino)benzoate, 2-(dimethylamino)ethyl (meth)acrylate, diethylaminoethyl(meth)acrylate, 2-(diisopropylamino)ethyl (meth)acrylate, 2-(acryloyloxy)ethyl 4-(dimethylamino)benzoate, 2-ethylhexyl 4-(dimethylamino)benzoate, ethyl 2-(dibutylamino)methyl acrylate and 4,4-(oxybis(ethane-2,1-diyl))bis(oxy)bis(dimethylaniline): 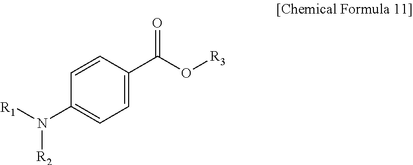
wherein, in Chemical Formula 11, R₁ and R₂ each independently represent an alkyl group having 1 to 5 carbon atoms, and R₃ represents an alkyl group having 1 to 20 carbon atoms, an ether group having 1 to 20 carbon atoms, an aryl group, an amine group or a (meth)acrylate group having 6 to 30 carbon atoms.

18. The photopolymerizable composition of claim 1, further comprising 0.1 to 10 parts by weight of a photosensitizer based on total 100 parts by weight of the high refractive index monomer and the flexible monomer.

19. The photopolymerizable composition of claim 18, wherein the photosensitizer is at least one selected from the group consisting of isopropyl thioxanthone, pyrene, perylene, triphenylene, anthracene, 9,10-dibutoxyanthracene, 9,10-diethoxyanthracene, 3,7-dimethoxyanthracene, and 9,10-dipropyloxyanthracene.

20. An optical member comprising:
a substrate; and
a cured film including a cured product of the photopolymerizable composition for highly flexible inkjet according to claim 1.

21. The optical member of claim 20, wherein a haze of a cured film is 3% or less, a refractive index is 1.58 or more, and an elongation is 5% or more.

22. A display device comprising the optical member of claim 20 as at least one of an optical film or a pattern film.
